(19) United States
(12) Patent Application Publication
(10) Pub. No.: US 2016/0034957 A1
(43) Pub. Date: Feb. 4, 2016

(54) Generating Advertisements for Search Results Associated With Entities Based on Aggregated Entity Bids

(71) Applicant: Quixey, Inc., Mountain View, CA (US)

(72) Inventor: Tomer Kagan, Sunnyvale, CA (US)

(73) Assignee: Quixey, Inc., Mountain View, CA (US)

(21) Appl. No.: 14/575,485

(22) Filed: Dec. 18, 2014

Related U.S. Application Data
(60) Provisional application No. 62/076,780, filed on Nov. 7, 2014.
(60) Provisional application No. 62/031,003, filed on Jul. 30, 2014.

(51) Int. Cl. G06Q 30/02; G06F 17/30

(52) U.S. Cl. CPC G06Q 30/0256; G06F 17/30867; G06Q 30/0275

(57) ABSTRACT

Techniques include receiving a search query, identifying access mechanisms (AMs) specifying states of software applications based on the query, selecting first and second subsets of the AMs, generating search results based on the first subset, and determining whether an AM included in the second subset is associated with a highest total advertisement (ad) bid price and/or number among AMs of the second subset. An AM may be associated with one or more ad bid prices and/or numbers via one or more advertisers each associating the AM with an ad bid price when the AM references an entity specified by the advertisers. The techniques include, in the event an AM of the second subset is associated with the highest total ad bid price and/or number, generating an advertised search result based on the AM and transmitting the search results and the advertised search result, and otherwise, transmitting only the search results.

### CROSS REFERENCE TO RELATED APPLICATIONS

This U.S. patent application claims priority under 35 U.S.C. §119(e) to U.S. Provisional Application 62/076,780, filed on Nov. 7, 2014, and to U.S. Provisional Application 62/031,003 filed on Jul. 30, 2014. The disclosures of these prior applications are considered part of the disclosure of this application and are hereby incorporated by reference in their entireties,

### TECHNICAL FIELD

This disclosure generally relates to the field of search, and more particularly to techniques for generating advertisements to he displayed along with search results.

### BACKGROUND

In recent years, the use of computers, smartphone, and other Internet-connected computing devices has grown significantly. Correspondingly, the number of software applications available for such computing devices has also grown. Today, many diverse software applications can be accessed on a number of different computing devices, including, but not limited to, smartphones, personal computers, automobiles, and televisions. These software applications can include business driven applications, games, educational applications, news applications, shopping applications, messaging applications, media streaming applications, and social networking applications, as some examples.

### SUMMARY

In one example, a method includes receiving a search query from a user device, identifying access mechanisms (AMs) based on the search query, and selecting first and second subsets of the identified AMs. In this example, each AM specifies an application state of an application and each subset includes one or more of the AMs. The method further includes generating search results based on the first subset, and determining whether an AM included in the second subset is associated with one or more of a highest total advertisement (ad) bid price and a highest total ad bid number among the one or more AMs included in the second subset. The method includes, in the event an AM included in the second subset is associated with the one or more of the highest total ad bid price and the highest total ad bid number, generating an advertised search result based on the AM, and transmitting the search results and the advertised search result to the user device. The method also includes, in the event an AM included in the second subset is not associated with the one or more of the highest total ad bid price and the highest total ad bid number, transmitting the search results to the user device.

In another example, a method includes receiving a first entity query from a first advertiser, identifying an AM based on the first entity query, displaying the AM to the first advertiser, receiving a first selection of the AM from the first advertiser, and receiving a first ad bid price associated with the first selection from the first advertiser, in this example, the AM specifies an application state of an application. The method further includes receiving a second entity query from a second advertiser that is different than the first advertiser, identifying the AM based on the second entity query, displaying the AM to the second advertiser, receiving a second selection of the AM from the second advertiser, and receiving a second ad bid price associated with the second selection from the second advertiser. The method also includes storing one or more of indications of the first and second selections of the AM and the first and second ad bid prices in an ad record.

In another example, a system includes a data store including a plurality of AMs, each AM specifying an application state of an application, and one or more computing devices configured to receive a search query from a user device, identify AMs in the data store based on the search query, and select first and second subsets of the identified AMs. In this example, each subset includes one or more of the AMs. The one or more computing devices are further configured to generate search results based on the first subset, and determine whether an AM included in the second subset is associated with one or more of a highest total ad bid price and a highest total ad bid number among the one or more AMs included in the second subset. The one or more computing devices are configured to, in the event an AM included in the second subset is associated with the one or more of the highest total ad bid price and the highest total ad bid number, generate an advertised search result based on the AM, and transmit the search results and the advertised search result to the user device. The one or more computing devices are also configured to, in the event an AM included in the second subset is not associated with the one or more of the highest total ad bid price and the highest total ad bid number, transmit the search results to the user device.

In another example, a system includes a data store including a plurality of AMs, each AM specifying an application state of an application, and one or more computing devices configured to receive a first entity query from a first advertiser, identify an AM in the data store based on the first entity query, display the AM to the first advertiser, receive a first selection of the AM from the first advertiser, and receive a first ad bid price associated with the first selection from the first advertiser. The one or more computing devices are further configured to receive a second entity query from a second advertiser that is different than the first advertiser, identify the AM in the data store based on the second entity query, display the AM to the second advertiser, receive a second selection of the AM from the second advertiser, and receive a second ad bid price associated with the second selection from the second advertiser. The one or more computing devices are also configured to associate one or more of the first and second selections of the AM and the first and second advertisement bid prices within an ad record.

In another example, a non-transitory computer-readable storage medium includes instructions that cause one or more computing devices to receive a search query from a user device, identify AMs based on the search query, and select first and second subsets of the identified AMs. In this example, each AM specifies an application state of an application and each subset includes one or more of the AMs. The instructions further cause the one or more computing devices to generate search results based on the first subset, and determine whether an AM included in the second subset is associated with one or more of a highest total ad bid price and a highest total ad bid number among the one or more AMs included in the second subset. The instructions cause the one or more computing devices to, in the event an AM included in the second subset is associated with the one or more of the highest total ad bid price and the highest total ad bid number, generate an advertised search result based on the AM, and transmit the search results and the advertised search result to the user device. The instructions also cause the one or more computing devices to, in the event an AM included in the second subset is not associated with the one or more of the highest total ad bid price and the highest total ad bid number, transmit the search results to the user device.

In another example, a non-transitory computer-readable storage medium includes instructions that cause one or more computing devices to receive a first entity query from a first advertiser, identify an AM based on the first entity query, display the AM to the first advertiser, receive a first selection of the AM from the first advertiser, and receive a first ad bid price associated with the first selection from the first advertiser. In this example, the AM specifies an application state of an application. The instructions further cause the one or more computing devices to receive a second entity query from a second advertiser that is different than the first advertiser, identify the AM based on the second entity query, display the AM to the second advertiser, receive a second selection of the AM from the second advertiser, and receive a second ad bid price associated with the second selection from the second advertiser. The instructions also cause the one or more computing devices to store one or more of indications of the first and second selections of the AM and the first and second ad bid prices in a record.

The details of one or more implementations of the disclosure are set forth in the accompanying drawings and the description below. Other aspects, features, and advantages will be apparent from the description and drawings, and from the claims.

### BRIEF DESCRIPTION OF DRAWINGS

FIG. 1A depicts an example environment including a search system, an advertisement system, an entity system, advertiser devices, and one or more user devices and data sources.

FIG. 1B depicts another example environment including the search system, advertisement system, entity system, advertiser devices, user devices, and data sources.

FIG. 2 depicts an example of a user device in communication with a search system, an advertisement system, and an entity system.

FIG. 3A is a functional block diagram of an example search system.

FIG. 3B is a functional block diagram of an example search module.

FIGS. 3C-3F depict example function records of a search data store.

FIG. 4A is a functional block diagram of an example search system in communication with an example advertisement system and an example entity system.

FIGS. 4B-4D depict example entity records of an entity data store.

FIGS. 4E-4G depict example advertisement records of an advertisement data store.

FIG. 5 is a data flow diagram illustrating an example flow of data among a search system, an advertisement system, and a user device.

FIG. 6 is a flow diagram that illustrates an example method for identifying access mechanisms and using them to generate search results and advertised search results.

FIG. 7 is a flow diagram that illustrates an example method for performing a search for access mechanisms based on a search query received from a user device.

FIGS. 8A-89 are flow diagrams that each illustrate an example method for receiving access mechanisms as search results and advertised search results at a user device.

FIGS. 9A-9C are flow diagrams that each illustrate an example method for bidding on an access mechanism associated with an entity at multiple advertiser devices.

FIGS. 10A-11B depict example graphical user interfaces (GUIs) that may be generated on a user device according to the present disclosure.

FIG. 12 depicts an example GUI that may be generated on an advertiser device according to the present disclosure.

### DETAILED DESCRIPTION

The present disclosure generally relates to the field of search, and, more particularly, to techniques for generating and displaying advertisements for search results that are associated with entities (e.g., nouns) specified by advertisers. According to the techniques of this disclosure, a user device may transmit a search query to a search system and receive search results and advertised search results that are responsive to the search query. The user device may display the search results and the advertised search results to a user of the user device. The search results and the advertised search results may each include one or more user selectable links that, when selected by the user, direct the user device to one or more application states within one or more web-based applications (e.g., applications accessible from a user device via a web browser), or within one or more native applications (e.g., applications that are installed on a user device). The user selectable links may indicate (e.g., using text and/or image data) to the user the corresponding application states within the web-based or native applications.

An application state of an application may refer to one or more web pages within a web-based application, or to one or more graphical user interfaces (GUIs), or so-called “screens,” within a native application. In general, an application state of this disclosure may refer to a configuration of a web-based or native application in which the application displays content to the user, such as information related to one or more products, services, or vendors provided by, or accessible via, the application. An application state, as used herein, may also refer to a function provided by a web-based or native application. As one example, an application state of a web-based or native online shopping application may correspond to a web page or screen of the application that describes (e.g., using text and/or image data) a particular product or service sold through the application (e.g., by one or more vendors associated with the application).

According to the techniques disclosed herein, the search system may receive the search query from the user device and generate the search results based on the received search query. For example, the search system may identify one or more access mechanisms (hereinafter, “AMs”) that each specify an application state of an application. As one example, the search system may identify one or more function records based on the search query, and select the AMs from the identified function records. The search system may then select first and second subsets of the identified AMs that each include one or more of the identified AMs. For example, the first and second subsets of the identified AMs may be mutually exclusive, or may share one or more common AMs. Additionally, the first and second subsets may include all or a subset of the identified AMs. In some examples, the first subset may include AMs that are more relevant to the search query compared to the AMs included in the second subset. For example, the AMs included in the second subset may represent AMs that are relevant to the search query, but are less relevant than the AMs included in the first subset. In these examples, the AMs of the second subset may not be transmitted to the user device along with the AMs of the first subset.

The search system may generate the search results based on the first subset of the identified AMs, and transmit the search results to the user device. The search system may also transmit the second subset of the identified AMs to an advertisement system (hereinafter, “ad system”), which may generate the advertised search results based on the second subset. For example, the ad system may determine whether any one of the AMs of the second subset is associated with one or more of a highest total advertisement bid price (hereinafter, “ad bid price”) and a highest total advertisement bid number (hereinafter, “ad bid number”) among the AMs of the second subset. Specifically, the ad system may first determine whether any of the AMs of the second subset correspond to a sponsored AM included in an advertisement record (hereinafter, “ad record”). In the event an AM of the second subset is associated with an ad record in this manner, the ad system may determine whether one or more of a total ad bid price and a total ad bid number associated with the AM (e.g., as specified in the ad record) is greater than a total ad bid price and/or number associated with any other AM of the second subset. A total ad bid price and/or number associated with an AM are described in greater detail below. In the event the ad system determines that the AM is associated with the highest total ad bid price and/or number, the ad system may generate an advertised search result based on the AM, and transmit the advertised search result to the user device. Alternatively, in the event the ad system determines that the AM is not associated with the highest total ad bid price and/or number, the ad system may refrain from generating an advertised search result based on the AM. In some examples, the ad system may determine that another AM of the second subset is associated with the highest total ad bid price and/or number, generate an advertised search result based on the other AM, and transmit the advertised search result to the user device. In other examples, the ad system may determine that none of the AMs of the second subset is associated with the highest total ad bid price and/or number, and refrain from generating any advertised search results based on the AMs of the second subset. In this manner, the techniques of this disclosure may enable advertisers to advertise search results (i.e., AMs) that are relevant to a user's search query, but which would not be otherwise displayed to the user in response to the search query (e.g., based on search result relevance or other logic). Specifically, as described herein, the techniques may enable the advertisers to advertise search results that are associated with the greatest cumulative ad bid amounts, the most ad bids, or any combination thereof.

Also according to the disclosed techniques, each of multiple advertiser devices may receive an entity query from a user (e.g., an advertiser) of the advertiser device, and transmit the entity query to the ad system. The ad system may identify one or more AMs based on the received entity query, and transmit the identified AMs to the advertiser device. For example, the ad system may identify one or more entity records included in an entity system based on the entity query, and identify the AMs based on the identified entity records. The advertiser device may receive the identified AMs that are responsive to the entity query, and display the identified AMs to the user of the advertiser device. The advertiser device may then receive one or more selections of the identified AMs, as well as one or more ad bid prices associated with the selections, from the user. The advertiser device may transmit the selections of the identified AMs and the ad bid prices to the ad system. The ad system may store indications of the selections of the identified AMs as one or more sponsored AMs, and the ad bid prices, in an ad record. The ad system may also store indications of selections of the sponsored AMs and ad bid prices associated with the selections received from other ones of the multiple advertiser devices in the same ad record. As such, the ad record may associate the AMs specified by the selections (i.e., the sponsored AMs) with the ad bid prices received from the one or more of the multiple advertiser devices. In this manner, the ad record may include data that represents one or more of a total ad bid price and a total ad bid number associated with the sponsored AMs. The ad system may then use the ad record to generate advertised search results in the manner described herein.

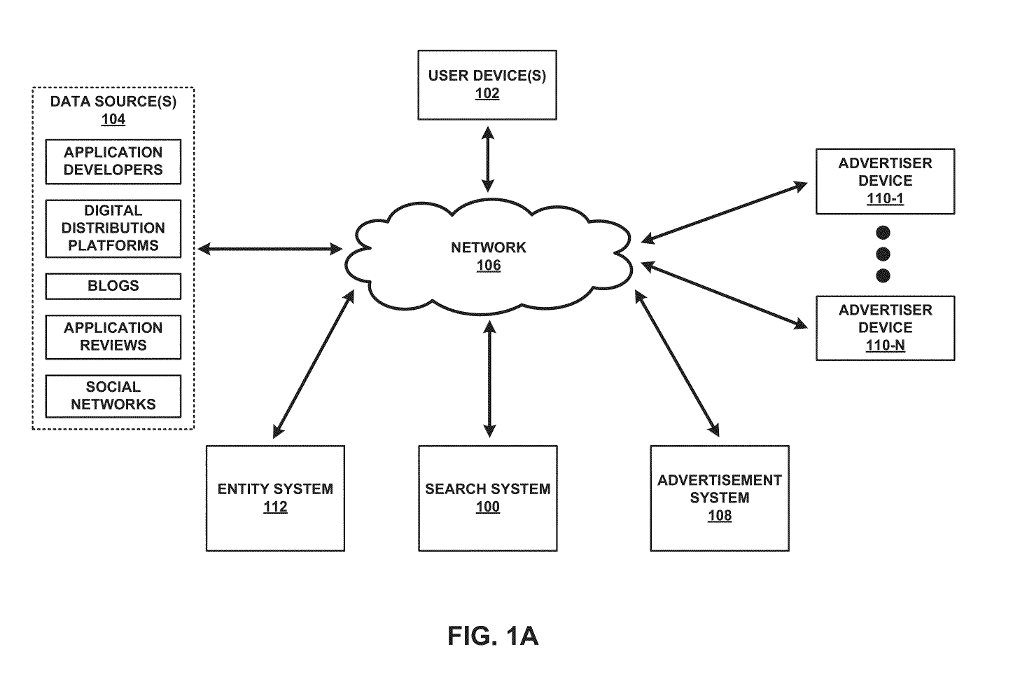

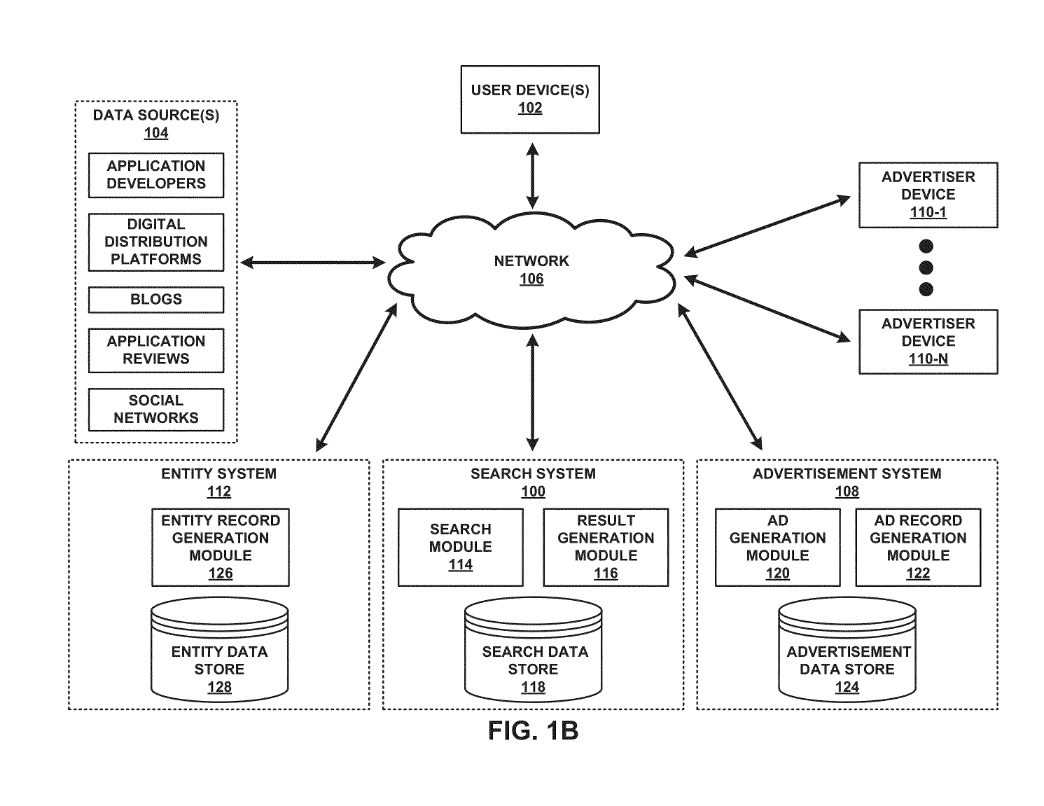

FIG. 1A is a functional block diagram that illustrates an example environment including a search system 100, an advertisement system 108 (hereinafter, “ad system 108”), and an entity system 112 that communicate with multiple advertiser devices 110 and one or more user devices 102 and data sources 104 via a network 106. In the example of FIG. 1A, the search system 100, ad system 108, and entity system 112 also communicate with one another. The network 106 through which these systems and devices communicate may include any type of network, e.g., a local area network (LAN), a wide area network (WAN), and/or the Internet.

In the example of FIG. 1A, the search system 100 receives a search query from one of the user device(s) 102 and generates search results, including one or more AMs, in response to the search query. The search system 100 transmits the search results to the user device 102. Upon receiving the search results, the user device 102 displays the search results to a user of the user device 102. The ad system 108 generates advertised search results, including one or more AMs, that are also responsive to the search query, and transmits the advertised search results to the user device 102. The user device 102 displays the advertised search results to the user along with the search results. The ad system 108 generates the advertised search results using advertisement data (hereinafter, “ad data”) specified by one or more advertisers via one or more of the advertiser devices 110. The ad data indicates one or more sponsored AMs that may be transmitted to the user device 102 as the advertised search results, and conditions for transmitting the AMs, as described herein. The advertisers may generate the ad data via the advertiser devices 110 using the ad system 108 and the entity system 112, as also described herein.

The search results and the advertised search results include AMs, each of which may he rendered as a user selectable link, displayed to the user, and selected by the user via the user device 102. An AM specifies an application state of a web-based or native application. Stated another way, an AM includes data that references the application and indicates one or more operations for the application to perform. In response to the user selecting a user selectable link for an AM included in the search results or the advertised search results, the user device 102 launches an application referenced by the AM. The user device 102 also causes the application to perform a function by performing one or more operations indicated by the AM. As a result, the application is configured, or set, into a particular application state that corresponds to the operations. For example, the application may be configured to display one or more products, services, or vendors, to the user, e.g., via a display device of the user device 102. In this manner, the application state of the application may refer to the operations and/or the outcome of the application performing the operations, in response to the user selecting the user selectable link.

In this disclosure, an application may refer to computer software that causes a computing device (e.g., the user device 102) to perform a task. In some examples, an application may be referred to as an “application,” “app,” or a “program.” Example applications include word processing applications, spreadsheet applications, messaging applications, media streaming applications, social networking applications, and games. Applications can be executed on a variety of different computing devices, including mobile computing devices such as smart phones, tablets, and wearable computing devices (e.g., headsets and/or watches). Applications can also be executed on other types of computing devices having other form factors, such as laptop computers, desktop computers, or other consumer electronic devices. In some examples, applications may be installed on a computing device prior to a user purchasing the device. In other examples, the user may download and install applications on the computing device.

The functionality of an application may be accessed on a computing device on which the application is installed, and/or via a remote computing device. In some examples, of an application's functionality may be included on a computing device on which the application is installed. In these examples, the application may function without communication with other computing devices. In other examples, an application installed on a computing device may access information from other remote computing devices during operation. For example, a weather application installed on a computing device may access the latest weather information via the Internet and display the information to a user. In still other examples, an application may be partially executed by a user's computing device and partially executed by a remote computing device. For example, a web-based application may be executed, at least in part, by a web server and accessed by a user via a web browser of the user's computing device. Example web-based applications include web-based email, online auctions, and online retail sites.

In this disclosure, a web-based or native application can perform any of a variety of different functions for the user of the user device 102. As one example, a restaurant reservation application can make reservations for restaurants. As another example, an Internet media player application can stream media (e.g., a song or a movie) from the Internet to the user device 102. In some examples, a single application can perform multiple functions. As one example, a restaurant reservation application can allow the user to retrieve information about a restaurant and read user reviews for the restaurant, in addition to making reservations for the restaurant. As another example, an internet media player application can allow the user to perform searches for digital media and generate music playlists, in addition to streaming media to the user's device.

An AM as described herein may include one of a native application AM (hereinafter, “application AM,” or “AAM”) and a web AM (hereinafter, “WAM”). As such, the user device 102 may use an AM of the present disclosure to access the functionality provided by a native or a web-based application. For example, the user may select a user selectable link that includes the AM to access the functionality of the application indicated in the user selectable link.

A WAM may include a resource identifier that includes a reference to a web resource (e.g., a page of a web application, or website). For example, the WAM may include a uniform resource locator (URL) (i.e., a web address) used with the hypertext transfer protocol (HTTP). If the user of the user device 102 selects a user selectable link that includes the WAM, the user device 102 may launch a web browser application included on the user device 102 and retrieve the web resource indicated in the resource identifier. Stated another way, if the user selects the user selectable link that includes the WAM, the user device 102 may launch the web browser application and access a state (e.g., a page) of a web application, or website. In some examples, the WAM may include a URL for a mobile-optimized site and/or a full site.

An AAM may be a string that includes a reference to a native application and indicates one or more operations for the user device 102 to perform. If the user selects a user selectable link that includes the AAM, the user device 102 may launch the native application referenced by the AAM and perform the operations indicated by the AAM. In other words, the user selecting the user selectable link that includes the AAM may cause the user device 102 to launch the native application referenced by the AAM and set the application into a state (e.g., in which the application displays a GUI, or screen) specified by the AAM.

In some examples, the AAM may include an application resource identifier (ARI) that references the native application and/or indicates the operations. In these examples, the ARI may be a string that has an application specific scheme. For example, the ARI may include a reference to the native application, a domain name, and a path for the application to retrieve and display information to the user. An example ARI for an application state of a native application “OPENTABLE®” by OpenTable, Inc. (hereinafter, “OpenTable”) for the Android® operating system (OS) is “vnd.opentable.deeplink://opentable.com/restaurant/profile?rid=88333&refid=1.” A portion of the ARI, i.e., the substring “vnd.opentable.deeplink,” references OpenTable. The ARI also indicates one or more operations for OpenTable to perform. Specifically, OpenTable may retrieve and display information included in the ARI domain and path defined by the substring “opentable.com/restaurant/profile?rid=88333&refid=1.” Upon receiving the ARI, the user device 102 may launch OpenTable and display information retrieved from the location indicated in the ARI. In some examples, the ARI may be provided by an application developer.

In sonic examples, the AAM may include only the ARI that references the native application and/or indicates the operations. In other examples, the AAM may include only the operations, i.e., without including the ARI. In these examples, the operations indicated by the AAM may reference the native application. The operations may include instructions for at least one of a search application, an OS, and the referenced native application included on the user device 102. In these examples, in response to the user selecting a user selectable link that includes the AAM, the user device 102 may identify the native application using the operations, launch the native application, and cause the native application to perform the operations. In still other examples, the AAM may include both the ARE and the operations.

In some examples, the AAM may include one or more operations for the user device 102 to perform in addition to the operations indicated by the ARI. For example, the search application, the OS, and/or the referenced native application may perform the additional operations. In some examples, the additional operations may be included in a script. Example additional operations include launching the native application, creating and sending a search request to an application server, setting a current geographic location in the application, making a restaurant reservation, sending a text message, and adding an appointment to a calendar.

As one example, an AM for a web-based or native restaurant reservation application includes data that enables the user device 102 to launch the application and mike a reservation at a restaurant using the application. In this example, to make the reservation, the user device 102 causes the application to perform one or more operations indicated by the AM. Performance of the operations sets the application into an application state in which the application displays information related to the reservation to the user. The information can include a reservation time, a description of the restaurant, user reviews, as well as any other information related to the reservation or the restaurant. As another example, an AM for a web-based or native internet media player application includes data that enables the user device 102 to launch the application and stream media (e.g., music) from the Internet to the user device 102 using the application. In this example, to stream the media, the user device 102 causes the application to perform one or more operations indicated by the AM. Performance of the operations sets the application into an application state in which the application displays to the user information regarding the media being streamed to the user device 102, such as a song name, an artist, or an album name.

AMs may have various different formats and content. The format and content of an AM may depend on the application associated with the AM and the one or more operations that are performed by the application based on the AM. For example, an AM for an internet music player application may differ from an AM for a shopping application. For instance, the AM for the internet music player application may include references to musical artists, songs, and albums. The AM may also reference one or more operations, such as randomizing a list of songs and playing a song or album. The AM for the shopping application may include references to one or more products that are sold via the application. The AM may also reference one or more operations, such as adding one or more products to a shopping cart and proceeding to a checkout.

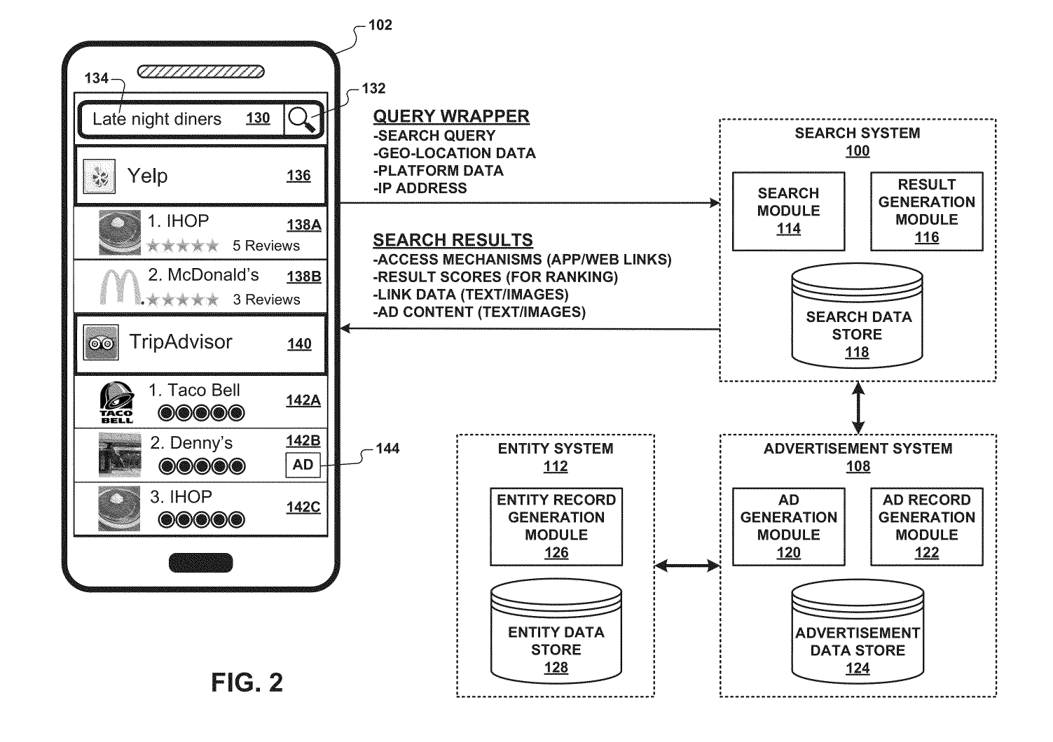

The search system 100 and the ad system 108 transmit the search results and the advertised search results, including the AMs, to the user device 102 along with additional data. For example, the systems 100, 108 may transmit link data (e.g., text and/or image data) that the user device 102 may use to generate one or more user selectable links for the AMs included in the search results and the advertised search results. The ad system 108 may also transmit ad content (e.g., text and/or image data) that the user device 102 may use to generate the user selectable links for the AMs included in the advertised search results. A user selectable link may include text and/or image(s) that a user may select (e.g., touch, or “click on”). Each user selectable link may be associated with an AM, such that when the user selects a particular link, the user device 102 launches a web-based or native application specified by the corresponding AM and causes the application to perform one or more operations indicated by the AM. The text and/or image(s) of the user selectable link may indicate the operations or function that the application performs in response to selection of the link. For example, if the user selectable link is for a song in a music player application, the text and/or image(s) may indicate that the user device 102 will launch the application, and that the application will play the song, when the user selects the link. Example user selectable links are shown in FIGS. 2, 10A, and 11A-11B.

FIG. 1B illustrates another example environment including the search system 100, the ad system 108, the entity system 112, the advertiser devices 110, the user device(s) 102, and the data source(s) 104. As shown in FIG. 1B, the search system 100 includes a search data store 118 (hereinafter, “data store 118”) that the search system 100 uses to generate the search results and provide data used by the ad system 108 to generate the advertised search results. The data store 118 may include one or more databases, indices (e.g., inverted indices), tables, files, or other data structures that may be used to implement the techniques of the present disclosure. In some examples, the data store 118 is included in one or more storage devices.

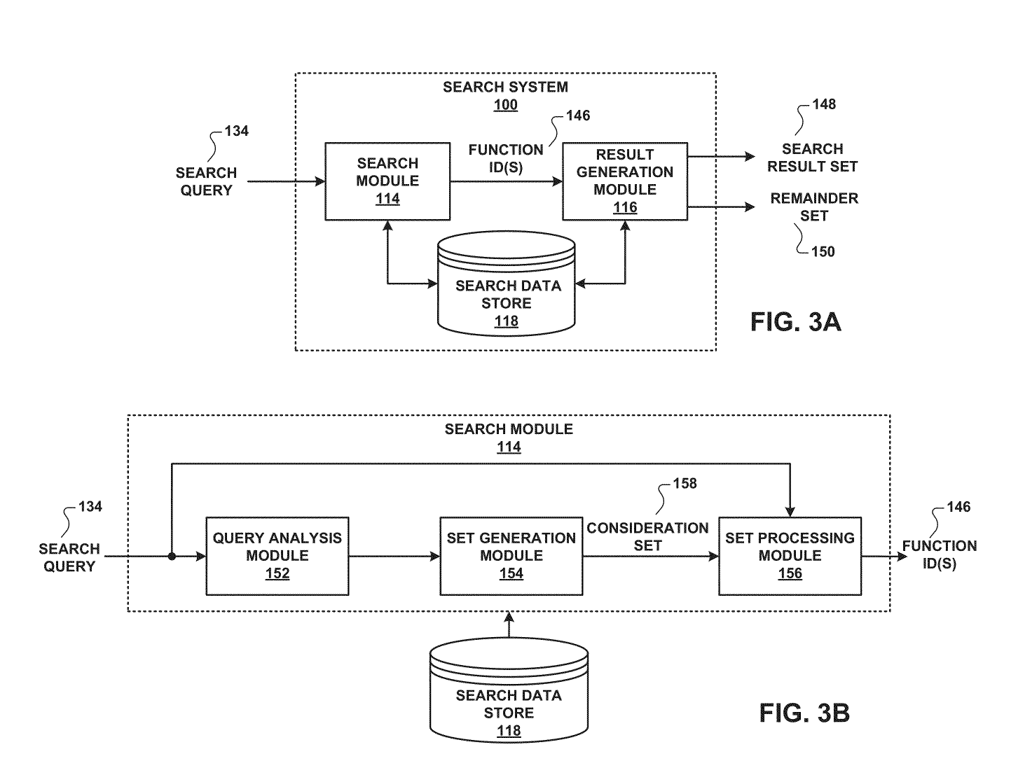

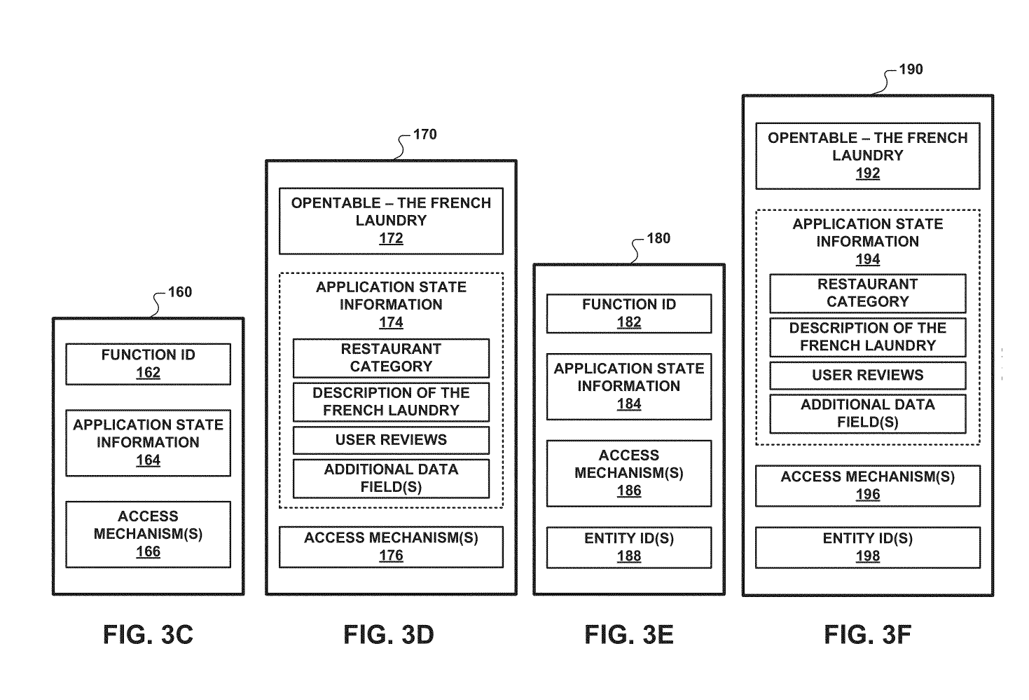

The data store 118 includes one or more function records (e.g., the function record 160 of FIG. 3C). Each function record may include data related to a function of a web-based or native application and/or to an application state of the application resulting from the application performing the function. For example, each function record may include a function identifier (ID), application state information (ASI), and one or more AMs. A function ID of a function record uniquely identifies the function record among other function records included in the data store 118. ASI of a function record includes data that describes an application state into which an application is set according to one or more AMs included in the function record. An AM of a function record includes data (e.g., a string) that causes the user device 102 to launch a web-based or native application and perform a function associated with the application.

A single application can provide different functionalities. For example, a restaurant reservation application can access reviews for a variety of different restaurants and set up reservations at the restaurants. Similarly, a travel application can book hotels, book flights, and provide reviews for different travel destinations. The different functionalities associated with a single application may be accessed using different AMs. For example, with respect to the restaurant reservation application, the data store 118 may include function records having different AMs for accessing different restaurant reviews and setting up reservations. Similarly, the data store 118 may include function records having different AMs for booking hotels, booking flights, and accessing reviews for different travel destinations.

In some examples, a function record may include multiple different AMs. For example, the AMs may be associated with different editions of an application. An edition of an application refers to a particular implementation or variation of the application. For example, the edition may refer to a version of the application, such as a version 1.0 or 2.0 of the application. In another example, the edition may refer to an implementation of the application for a specific platform, such as a specific OS. The AMs included in the function record may cause the corresponding application editions to launch and perform similar functions. Accordingly, the AMs may cause the corresponding application editions to be set into similar application states. In one example, the different AMs reference different editions of an information retrieval application and cause the corresponding application editions to retrieve similar information. In another example, the different AMs reference different editions of an interact music player application and cause the corresponding application editions to play the same song.

As an example, a function record for an application state of an application that retrieves restaurant information may include multiple different AMs for multiple different editions of the application. In this example, the function record is associated with a specific Mexican restaurant. The AMs for the different application editions may cause each edition to retrieve information for the same specific Mexican restaurant. For example, a first AM may cause a first application edition (e.g., for a first OS) to retrieve information for the restaurant, and a second AM may cause a second application edition (e.g., for a second OS) to retrieve information for the same restaurant.

In some examples, the search system 100 may identify function records included in the data store 118 that each include multiple AMs. For each function record including multiple AMs, the search system 100 may select some or all of the AMs for transmission to the user device 102 as part of the search results, or to the ad system 108 for generating the advertised search results. In some examples, the search system 100 may transmit all AMs of a function record to the user device 102. The user device 102 may determine which of the AMs to use to access an application state associated with the function record. Similarly, the search system 100 may transmit all AMs of a function record to the ad system 108. The ad system 108 may determine which of the AMs to transmit to the user device 102 as part of the advertised search results. In other examples, the search system 100 may determine which of the AMs to transmit to the user device 102 and/or the ad system 108 based on information included in a query wrapper received from the user device 102. The information may indicate various properties of the user device 102, e.g., the OS, or device type, of the user device 102. Using the information, the search system 100 may transmit one or more of the AMs of the function record that are likely to be compatible with the user device 102 to the user device 102 and/or the ad system 108.

In some examples, a function record may also include information that describes values of one or more metrics associated with a person, place, or thing described in the function record. Example metrics include the popularity of a place described in the function record and/or ratings (e.g., user ratings) of the place. For example, if the function record describes a song, a metric associated with the song may be based on the popularity of the song and/or ratings (e.g., user ratings) of the song. The information included in the function record may also be based on measurements associated with the function record, such as how often the function record is retrieved during a search and how often user selectable links for AMs of the function record are selected by a user. The information may also indicate whether the function record includes an AAM for a default application state, or a deeper application state, of a native application.

As described herein, the search system 100 receives the search query from the user device 102 and generates the search results in response to the search query. The search query may include text, numbers, and/or symbols (e.g., punctuation) entered into the user device 102 by the user. For example, the user may have entered the search query into a search field, or “search box,” of a search application included on the user device 102. The user may have entered the search query using a touchscreen keypad, a mechanical keypad, and/or via speech recognition techniques. As described herein, in some examples, the search application may be a native application dedicated to search, or a more general application, such as a web browser.

In some examples, the user device 102 may transmit additional data to the search system 100 along with the search query. The search query and the additional data may be referred to as a query wrapper. The additional data may be associated with the search query and may include geo-location data for the user device 102, platform data for the user device 102 (e.g., a type and/or a version of the user device 102, the OS, and/or the web browser), an identity of the user (e.g., a username), partner specific data, and other data. The user device 102 transmits the query wrapper to the search system 100. The search system 100 may use the search query and/or the additional data included in the query wrapper to generate the search results and provide information to the ad system 108 to generate the advertised search results.

The search system 100 also includes an application search module 114 (hereinafter, “search module 114”) that identifies one or more function records included in the data store 118 based on the search query. Initially, the search module 114 analyzes the search query. The search module 114 then identifies one or more function records included in the data store 118 based on the analyzed search query. For example, the search module 114 may identify the function records based on matches (e.g., text matches) between terms of the search query and terms of ASI included in the identified function records. The search module 114 then processes (e.g., scores) the identified function records. For example, the search module 114 may determine how well the identified function records match the search query. The search module 114 may then select one or more of identified the function records that best match the search query. The search module 114 may transmit function IDs associated with the selected function records to a result generation module 116 also included in the search system 100.

The result generation module 116 may identify the function records selected by the search module 114 in the data store 118 using the received function IDs. The result generation module 116 may then select one or more AMs from the function records. As described herein, the result generation module 116 may select first and second subsets of the function records, and select AMs from the function records of the first and second subsets. The result generation module 116 may transmit the AMs included in the function records of the first subset to the user device 102 as search results. The result generation module 116 may also transmit the AMs included in the function records of the second subset to the ad system 108 so that the ad system 108 may generate advertised search results, as also described herein. The ad system 108 may transmit the advertised search results to the user device 102. In some examples, the result generation module 116 may transmit function IDs that correspond to the function records of the second subset to the ad system 108, rather than the AMs selected from the function records. In these examples, the ad system 108 may access the function records in the data store 118 using the received function IDs, and select the AMs from the function records.

The search system 100 (e.g., the result generation module 116) may transmit additional data along with the AMs to the user device 102 and the ad system 108. For example, the search module 114 may generate result scores for the function records from which the AMs are selected (e.g., using values of metrics associated with the persons, places, or things described in the function records). As such, each AM may be associated with a result score that indicates the rank of the AM relative to the other AMs. In these examples, the search system 100 may also transmit the result scores to the user device 102 and the ad system 108 along with the AMs.

As described herein, the ad system 108 uses the AMs (or function IDs) received from the search system 100 (i.e., the result generation module 116) to generate one or more advertised search results to be displayed to the user of the user device 102. Specifically, an advertisement generation module 120 (hereinafter, “ad generation module 120”) of the ad system 108 generates an advertised search result for an AM received from the search system 100 when the ad generation module 120 determines that the AM is associated with one or more of a highest total ad bid price and a highest total ad bid number among the one or more AMs received by the ad system 108 from the search system 100. For example, the ad generation module 120 may determine that the AM is associated with the highest total ad bid price and/or number by first identifying an ad record included in an advertisement data store 124 (hereinafter, “data store 124”) that includes a sponsored AM that corresponds to the AM. As explained herein, the ad record may specify one or more of a total ad bid price and a total ad bid number associated with the AM. The total ad bid price may represent a sum of all ad bid prices received from one or more advertisers that included the AM in the advertisers' advertisement bids. The total ad bid number may represent a number of all of the ad bid prices, or a number of all indications of selections of the AM received from the advertisers as part of the advertisement bids, as described in greater detail below. The ad generation module 120 may determine that the AM is associated with the highest total ad bid price and/or number by comparing the total ad bid price and/or number associated with the AM to a total ad bid price and/or number associated with each of one or more other AMs received by the ad system 108 from the search system 100. Upon making this determination, the ad generation module 120 generates an advertised search result for the AM and transmits the result to the user device 102, e.g., directly, via the search system 100, or via another system or device. The user device 102 displays the advertised search result to the user along with the search results received from the search system 100 as user selectable links.

Alternatively, the ad system 108 may select one or both of the first and second subsets of the function records and select the AMs from the function records, in a similar manner as described above with reference to the result generation module 116. In these examples, the ad system 108 may transmit the AMs included in the function records of the first subset to the user device 102 as search results, and use the AMs included in the function records of the second subset to generate advertised search results in the manner described above.

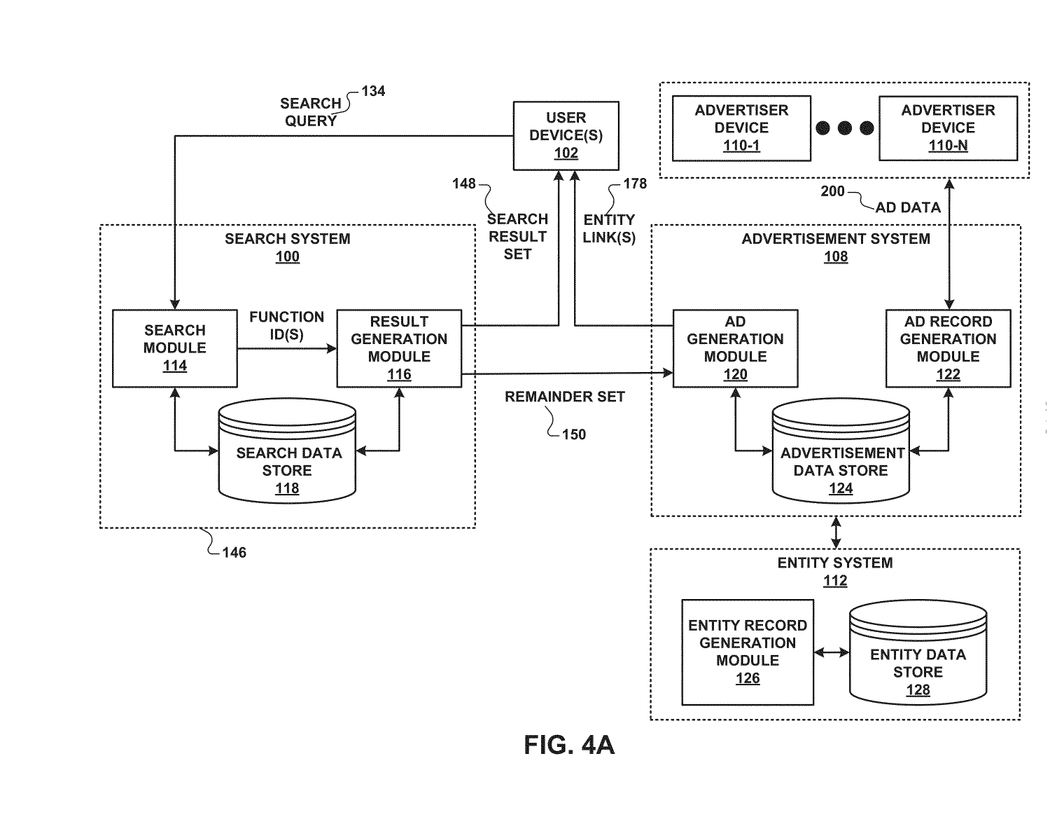

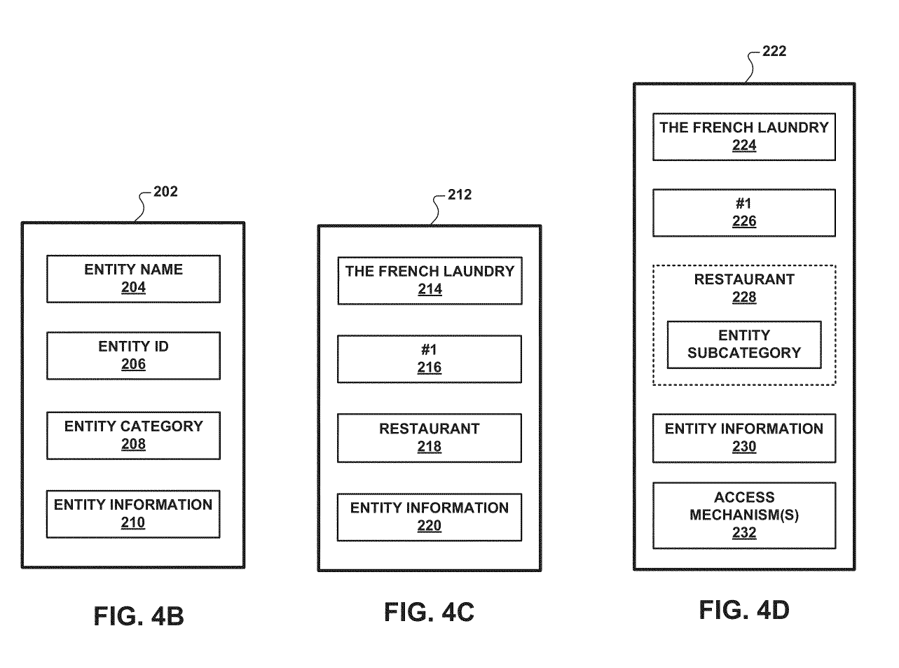

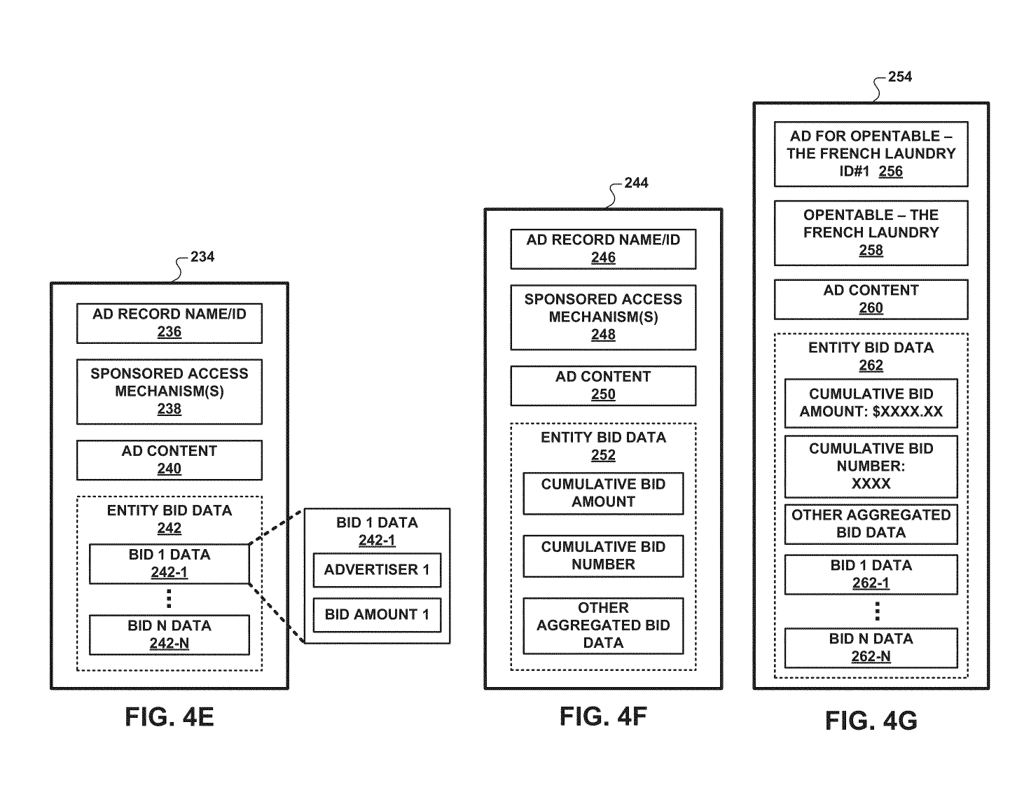

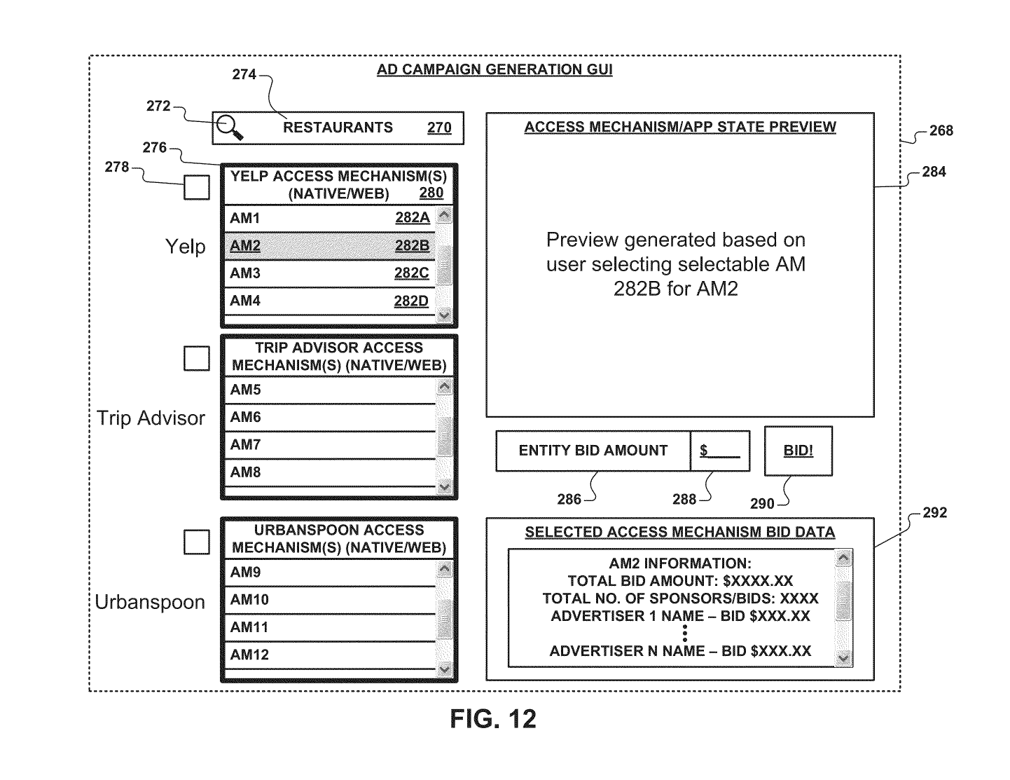

As described herein, the ad system 108 uses the data store 124 to generate advertised search results based on AMs (or function IDs) received from the search system 100. In some examples, the data store 124 is included in one or more storage devices. The data store 124 includes data associated with one or more advertisements. The data associated with an advertisement may be referred to as an ad record (e.g., the ad record 234 of FIG. 4E). The data store 124 may include one or more ad records that each include data for a different advertisement. The ad records may be generated using the advertiser devices 110, an ad record generation module 122 of the ad system 108, and an entity data store 128 (hereinafter, “data store 128”) of the entity system 112, as described with reference to FIG. 12. The ad records may be generated by advertisers, by ad agencies, or by providers of any of the application search and advertisement generation functionalities described herein.

An ad record may include a variety of different types of data related to an advertisement. For example, the ad record may include data that identifies the ad record, such as an ad record name and/or ID that identifies the ad record among other ad records in the data store 124. The ad record may also include one or more sponsored AMs associated with the ad record. Each sponsored AM may specify an application state of a web-based or native application which an advertiser has paid to have displayed to a user as an advertised search result. For example, the advertiser may pay to have the advertised search result generated, transmitted, and displayed to the user when the sponsored AM is identified based on a user's search query. The ad record may also include an indication of an amount paid by the advertiser to advertise the sponsored AM, which may be referred to herein as an ad bid price. In this example, the advertised search result for the sponsored AM may be generated, transmitted, and displayed to the user when a total ad bid price for the ad record is greater than a total ad bid price associated with each of one or more other ad records associated with other sponsored AMs, as described herein. The ad record may also include advertisement content (hereinafter, “ad content”) used to generate the advertised search result using the sponsored AM. The ad content may include text, image, and/or video data specified by the advertiser.

The data store 128 of the entity system 112 includes data associated with one or more different entities. The data store 128 may include one or more databases, indices (e.g., inverted indices), files, or other data structures storing the data. The data store 128 of the present disclosure includes one or more entity records (e.g., the entity record 202 of FIG. 4B). Each entity record includes data associated with a different entity. For example, an entity record may include data that is descriptive of an entity. The term “entity” may generally refer to a noun (e.g., a person, animal, place, or thing). An entity may also include other parts of speech (e.g., verbs, adjectives, etc.). For example, an entity may correspond to a name of a business, product, service, a piece of media content, political organization/figure, public figure, destination, or any other suitable item of commerce which may be advertised in connection with an application. Accordingly, entities that may be used to generate advertised search results according to the techniques disclosed herein can include businesses, products, services, media contents, political organizations/figures, public figures, destination places (e.g., city, state, country), or any other suitable items of commerce referenced in an application.

An entity record may be a data structure that includes an entity name, an entity ID, an entity category, and entity information. An entity name of an entity record may include one or more words, numbers, and/or symbols (e.g., punctuation marks). An entity ID of an entity record may identify the entity record among the other entity records included in the data store 128. An entity category of an entity record may indicate a category in which the entity name and the entity information belong. Entity information of an entity record may refer to data included in the entity record in addition to the entity name and the entity category.

The entity system 112 also includes an entity record generation module 126 that may be used to generate the entity records included in the data store 128. For example, the entity system 112 may retrieve entity data from various data sources (e.g., the data source(s) 104). The retrieved entity data may include any type of data related to entity records described herein, e.g., an entity name, an entity category, entity information, and associated AMs or applications.

The entity system 112 may be configured to generate and update the data store 128 based on the entity data retrieved from the data sources. For example, the entity system 112 may use the entity data to update one or more databases, indices, files, or other data structures included in the data store 128. The entity system 112 may generate new entity records and update existing entity records based on the entity data retrieved from the data sources. In some examples, some data included in the data store 128 may be manually generated.

The user device(s) 102 can be any computing devices capable of providing search queries to the search system 100 and receiving search results and advertised search results from the search system 100 and the ad system 108. The user device(s) 102 may include smart phones, and tablet, laptop, or desktop computers. The user device(s) 102 may also include computing devices having other form factors, e.g., computing devices included in vehicles, gaming devices, televisions, or other appliances (e.g., networked home automation devices and home appliances).

The user device(s) 102 may use a variety of different operating systems or platforms. In an example where a user device 102 is a mobile device, the user device 102 may operate using an OS such as ANDROID® by Google, Inc., IOS® by Apple, Inc., or WINDOWS PHONE® by Microsoft Corporation. In an example where the user device 102 is a laptop or desktop computing device, the user device 102 may use an OS such as MICROSOFT WINDOWS® by Microsoft Corporation, MAC OS® by Apple, Inc., or LINUX® (LINUX® is the registered trademark of Linus Torvalds in the U.S. and other countries). The user device(s) 102 may interact with the search system 100 and/or the ad system 108 using operating systems other than those described herein, whether presently available or developed in the future.

The user device(s) 102 can communicate with the search system 100 and the ad system 108 via the network 106. In general, the user device(s) 102 may communicate with any of the systems 100, 108 using any application that can transmit search queries to the search system 100 and receive search results and advertised search results from the search system 100 and the ad system 108. In some examples, the user device 102 may include an application that is dedicated to interfacing with one or more of the systems 100, 108, such as an application dedicated to searches (e.g., a search application). In other examples, the user device 102 may communicate with any of the systems 100, 108 using a more general application, such as a web browser. In any case, an application included on the user device 102 to communicate with one or more of the systems 100, 108 may include a GUI with a search field, or search box, into which the user of the user device 102 may enter search queries, e.g., using a touchscreen, physical keyboard, a speech-to-text program, or other form of user input available on the user device 102.

A user device 102 may use a GUI of the search application, or a more general application, included on the user device 102 to display the search results and the advertised search results. The user device 102 may also use the GUI to receive search queries from the user and transmit the search queries to the search system 100. The GUI may display the search results and the advertised search results to the user in a variety of different ways, depending on the information transmitted to the user device 102 from the search system 100 and the ad system 108. In examples where the search results and advertised search results include one or more AMs, the search system 100 and the ad system 108 may transmit the AMs to the user device 102 along with link data and/or ad content used to generate one or more user selectable links for the AMs. In some examples, the GUI may display the search results and the advertised search results to the user as a list of the user selectable links, including text and/or image(s). For example, the text and/or images(s) may include names of applications specified by the AMs, descriptions of the AMs and/or operations indicated therein, and images associated with the applications, or application states thereof, referenced by the AMs (e.g., application, or application state, icons or “screens”). In some examples, the GUI may display the search results and the advertised search results as the list of the user selectable links arranged under a search field into which the user has entered a search query. The GUI may arrange the user selectable links by result scores associated with the links, i.e., with the AMs for which the links are generated, or using other logic. The GUI may also group the user selectable links by application.

The advertiser devices 110 can be any computing devices capable of receiving entity queries from users of the advertiser devices 110, providing the entity queries to the ad system 108, receiving AMs identified by the ad system 108 based on the entity queries, and displaying the AMs to the users. The advertiser devices 110 can also be any computing devices capable of receiving selections of the AMs, ad bid prices, and additional parameters from the users, and transmitting this information to the ad system 108. For example, the advertiser devices 110 can be any computing devices capable providing a GUI that enables the users of the advertiser devices 110 to interact with the ad system 108 in the manner described herein.

The data source(s) 104 may be sources of data which the search system 100 may use to generate and/or update the data store 118. For example, the search system 100 may use the data source(s) 104 to generate and/or update one or more databases, indices, tables, files, or other data structures included in the data store 118. The search system 100 may generate new function records and update existing function records based on data retrieved from the data source(s) 104. The search system 100 may include modules that generate new function records and/or update existing function records based on the data retrieved from the data source(s) 104. In some examples, some or all of the data included in the data store 118 (e.g., one or more function records) may be manually generated by a human operator. The entity system 112, or another system, may also use the data source(s) 104 to generate and/or update the data store 128.

The data source(s) 104 may include a variety of different data providers. For example, the data source(s) 104 may include data from application developers, such as application developer websites and data feeds provided by application developers. The data source(s) 104 may also include operators of digital distribution platforms configured to distribute applications to user device(s) 102. The data source(s) 104 may further include other websites, such as websites that include web logs (i.e., blogs), application reviews, or other data related to applications. Additionally, the data source(s) 104 may include social networking sites, such as “FACEBOOK®” by Facebook, Inc. (e.g., Facebook posts) and “TWITTER®” by Twitter, Inc. (e.g., text from tweets). The data source(s) 104 may also include online databases that include data related to movies, television programs, music, and restaurants. The data source(s) 104 may include other types of data sources, which may have various types of content and update rates.

In some examples, the search system 100 may retrieve data from the data source(s) 104, including any type of data related to application functionality and/or application states. The search system 100 may then generate one or more function records stored in the data store 118 based on the data. In other examples, some or all of the data included in the function records (e.g., ASI) may be manually generated by a human operator. In any case, the data included the function records may be updated over time so that the search system 100 and the ad system 108 provide up-to-date search results and advertised search results.

FIG. 2 illustrates an example user device 102 in communication with the search system 100 and the ad system 108. In this example, the ad system 108 also communicates with the entity system 112. The user device 102 displays search results received from the search system 100 and the ad system 108 in the form of user selectable links 136, 138A-138B, 140, and 142A-142C (collectively, the “links”). Each link includes link data, i.e., text (e.g., a name of an application, or an application state) and an image (e.g., an icon for the application, or application state) that describe the application, or application state, associated with the link. For example, the links 138A-138B describe the application states, or entries, for “IHOP” and “McDonald's” within the application “YELP®” by Yelp, Inc. (hereinafter, “Yelp”). The link 136, which is a header, may describe the main, or default, application state within Yelp, as explained herein.

Each link may be associated with an AM, such that when a user of the user device 102 selects the link, the user device 102 launches the corresponding application and sets it into an application state specified by the AM. The user device 102 may receive the AMs associated with the links 138A-138B and 142A-142C as part of the search results. The user device 102 may generate the AMs associated with the links 136 and 140 (i.e., headers) using the received AMs (e.g., portions of the received AMs). In some examples, the links 136 and 140 may not be associated with AMs. As described below, the links 138A-138B and 142A-142C may be arranged for display to the user based on result scores of function records that include the AMs associated with the links. Also, as shown in FIG. 2, links for the same application (e.g., Yelp) may be displayed together (e.g., grouped) using a header (e.g., the links 136 and 140).

As shown in FIG. 2, the user device 102 transmits the query wrapper to the search system 100. The query wrapper may include a search query 134 (“Late night diners”), geo-location data, platform data, and/or other data (e.g., an IP address) associated with the user, the user device 102, and/or the search query 134. The user may have entered the search query 134 into a search field 130 of a GUI of a search application included on the user device 102, and submitted the search query 134 using a search button 132 of the GUI. In response to the query wrapper, the search system 100 and the ad system 108 transmit the search results to the user device 102. The search results may include AMs, result scores, link data, and ad content.

In the example of FIG. 2, the search results include search results received from the search system 100 and an advertised search result received from the ad system 108. Specifically, the search results received from the search system 1100 correspond to AMs for the links 138A-138B, 142A, and 142C. The advertised search result received from the ad system 108 corresponds to the AM for the link 142B. The search system 100 transmits the AMs for the links 138A-138B, 142A, and 142C to the user device 102, e.g., along with associated link data. The search system 100 transmits the AM for the link 142B, as well as one or more other AMs, to the ad system 108. The ad system 108 determines that the AM for the link 142B is associated with a highest total ad bid price and/or number among the AMs transmitted by the search system 100 to the ad system 108 based on one or more ad records included in the data store 124, including an ad record associated with the AM for the link 142B. The ad system 108 generates the advertised search result that includes the AM, and transmits the advertised search result to the user device 102. The advertised search result may also include link data and ad content for the AM included in the ad record associated with the AM, as described herein.

In this example, the ad system 108 may generate the ad record associated with the AM, or update an existing ad record that is associated with the AM, based on one or more inputs from one or more users (e.g., advertisers) of one or more of the advertiser devices 110. For example, the ad system 108 may receive an entity query from each advertiser device 110 and search the data store 128 for one or more entity records based on the entity query. The ad system 108 may identify the entity records in the data store 128 in a variety of different ways. As one example, the ad system 108 may identify the entity records by detecting matches, or near matches, between terms (e.g., one or more words) of the entity query and terms included in each identified entity record. For example, the ad system 108 may identify each entity record by detecting matches between terms of the entity query and terms included in the entity name, entity category, and/or entity information of the entity record. The ad system 108 may apply various heuristics and other techniques to further filter and score the identified entity records.

The ad system 108 may identify one or more AMs, including the AM for the link 142B, based on the identified entity records and display the AMs to the user of the advertiser device 110. In some examples, the entity records may include the AMs. In other examples, the ad system 108 may search the data store 118 to identify one or more function records that include the AMs using data (e.g., entity name, category, and/or information) included in the entity records. The ad system 108 may receive one or more user selections of the displayed AMs, including a selection of the AM for the link 142B, and an ad bid price associated with each selection, from the user. The ad system 108 may store an indication of the selection of the AM and the ad bid price associated with the selection in the ad record. The ad system 108 may store one or more additional indications of selections of the AM and ad bid prices associated with the selections received from users of other ones of the advertising devices 110 in the same ad record.

FIG. 3A illustrates an example search system 100. In this example, the search module 114 receives a search query 134 from one of the user device(s) 102 and identifies one or more function records in the data store 118 based on the search query 134. The search module 114 transmits one or more function IDs 146 associated with the identified function records to the result generation module 116. The result generation module 116 generates a search result set 148 (i.e., search results) and a remainder set 150 based on the function ID(s) 146. The search result set 148 includes one or more AMs selected from a first subset of the identified function records. In some examples, the remainder set 150 includes one or more AMs selected from a second subset of the identified function records. Alternatively, in other examples, the remainder set 150 includes one or more function IDs associated with the second subset. The result generation module 116 transmits the search result set 148 and the remainder set 150 to the user device 102 and the ad system 108, respectively.

FIG. 3B is a functional block diagram of an example of the search module 114 described above with reference to FIG. 3A. In this example, the search module 114 includes a query analysis module 152, a consideration set generation module 154 (hereinafter “set generation module 154”), and a consideration set processing module 156 (hereinafter “set processing module 156”). The query analysis module 152 receives a query wrapper that includes a search query 134, e.g., from the user device 102, and analyzes the search query 134. For example, the query analysis module 152 may perform various analysis operations on the search query 134, including tokenization, filtering, stemming, synonymization, or stop word removal.

The set generation module 154 identifies one or more function records in the data store 118 based on the search query 134. The identified function records may be referred to herein as a “consideration set” 158. In some examples, the set generation module 154 may identify the function records of the consideration set 158 based on one or more matches between one or more terms of the search query 134 and one or more terms included in the function records. For example, the set generation module 154 may identify the function records based on matches between tokens generated by the query analysis module 152 and words included in the function records, e.g., in the ASI and/or function IDs of the function records.

The set processing module 156 processes (e.g., scores) the function records of the consideration set 158 and transmits one or more function IDs 146 associated with the processed function records to the result generation module 116. In some examples, the set processing module 156 scores the function records by generating a result score for each function record. In these examples, the result scores may be transmitted to the result generation module 116 along with the function ID(s) 146 for the function records of the consideration set 158.

The set processing module 156 may generate the result scores for the function records of the consideration set 158 in a variety of different ways. In some examples, the set processing module 156 generates a result score tier a function record based on one or more scoring features. The scoring features may be associated with the function record and/or the search query 134 that resulted in identification of the function record by the set generation module 154. A scoring feature for the function record (“record scoring feature”) may be based on any data associated with the function record, e.g., data included in ASI of the function record. Example record scoring features for the function record include the popularity and/or ratings (e.g., user ratings) of the place described in the function record, measurements associated with the function record, such as how often the function record is retrieved during a search and how often user selectable links for AMs of the function record are selected by a user, whether the function record includes an AAM that specifies a default application state, or a deeper application state, of a native application, or any other data specific to the function record. A scoring feature for the search query 134 (“query scoring feature”) may include any data associated with the search query 134. Example query scoring features for the search query 134 include a number of words in the search query 134, the popularity of the search query 134, and the expected frequency of the words in the search query 134. A scoring feature for the function record and the search query 134 (“record-query scoring feature”) may include any data that may be generated based on data associated with both the function record and the search query 134. Example record-query scoring features for the function record and the search query 134 include parameters that indicate how well the terms of the search query 134 match the terms of the ASI and/or the function ID of the function record. The set processing module 156 may generate the result score for the function record based on a record scoring feature, a query scoring feature, and/or a record-query scoring feature.

The set processing module 156 may determine result scores for function records in the consideration set 158 based on one or more of the scoring features described above and/or any additional scoring features. In some examples, the set processing module 156 may include one or more machine-learned models (e.g., a supervised learning model) configured to receive one or more scoring features. The one or more machine-learned models may generate the result scores for the function records based on one or more of the record scoring features, query scoring features, and record-query scoring features. For example, the set processing module 156 may pair the search query 134 with each function record in the consideration set 158 and compute a vector of features for each (query, record) pair. The vector of features may include one or more record scoring features, one or more query scoring features, and one or more record-query scoring features. The set processing module 156 may then input the vector of features into a machine-learned regression model to calculate a result score for the corresponding function record. In some examples, the machine-learned regression model may include a set of decision trees (e.g., gradient boosted decision trees). In other examples, the machine-teamed regression model may include a logistic probability formula. In some examples, the machine-learned task described above can be framed as a semi-supervised learning task, where a minority of training data used to create the machine-learned regression model is labeled with human curated result scores, and the rest of the training data is used without human curated result score labels.

The result generation module 116 may receive the function ID(s) 146 and the result scores and select first and second subsets of function records from the consideration set 158 based on the result scores associated with the function records. For example, the result generation module 116 may select one or more function records having the highest result scores from the consideration set 1158 as the first subset. The result generation module 116 may select one or more AMs from the first subset and transmit the AMs to the user device 102 as a search result set 148, e.g., with the result scores associated with the selected AMs. An AM may be associated with a result score of a function record from which the AM is selected. The result generation module 116 may also select one or more other function records (e.g., those having relatively lower result scores) from the consideration set 158 as the second subset. The result generation module 116 may select one or more AMs from the second subset and transmit the AMs to the ad system 108 as a remainder set 150, e.g., with the associated result scores.

The result scores associated with the AMs in the search result set 148 and the remainder set 150 may be used in a variety of different ways. In some examples, the result scores may be used to rank the AMs within a list fur display to a user of the user device 102. In these examples, a larger result score may indicate that the corresponding AM (e.g., an application state) is more relevant to the user's search query 134 than an AM having a smaller result score. In examples where the AMs are displayed to the user as a list of user selectable links (“links”), links for AMs associated with larger result scores may be listed higher within the list (e.g., near the top of a screen) than links for AMs associated with lower results scores. In these examples, links for AMs having lower result scores may be located farther down the list (e.g., off screen) and may be accessed by scrolling down a screen of the user device 102.

The result scores may indicate the relevance of a particular application state described by a function record in the consideration set 158 to the search query 134, the popularity of the application state, or other properties of the application state, depending on which parameters the set processing module 156 uses to score the function records of the consideration set 158.

FIGS. 3C-3D illustrate example function records 160 and 170, respectively, that may be included in the data store 118. The function record 160 of FIG. 3C includes a function ID 162, ASI 164, and one or more AMs 166. The function record 160 may include data related to a function of a web-based or native application. For example, the function record 160 may include data related to an application state of the application that corresponds to, or results from, the application performing the function. The data store 118 may include one or more other function records that are each similar in structure to the function record 160. In other words, the data store 118 may include one or more function records each having a function ID, ASI, and AM(s).

The function ID 162 may be used to identify the function record 160 among other function records included in the data store 118. The function ID 162 may be a string of alphabetic, numeric, and/or symbolic characters (e.g., punctuation marks) that uniquely identify the function record 160. In some examples, the function ID 162 may describe a function and/or an application state of an application in human readable form. For example, the function ID 162 may include a name of an application referenced by the AM(s) 166. Additionally, or alternatively, the function ID 162 may include a human readable string that describes a function performed by the application according to the AM(s) 166, and/or an application state resulting from performance of the function. In some examples, the function ID 162 may include a string in the format of a uniform resource locator (URL), which may uniquely identify the function record 160. In these examples, the URL may specify the same or similar application state as the AM(s) 166 within a web-based version of the application referenced by the AM(s) 166.

In one example, the function ID 162 may include the string “www.yelp.com/biz/the-french-laundry-yountville-2?ob=1” in the format of a URL that uniquely identifies the function record 160. In another example, the function record 160 describes a function of Yelp. In this example, the function ID 162 may include the name “Yelp” along with a description of an application state within Yelp, e.g., as specified by the ASI 164. In still another example, the function record 160 describes an entry for the restaurant “The French Laundry®” within Yelp. In this example, the function ID 162 may be “Yelp—The French Laundry.”

The ASI 164 may include data that describes the application state into which the application referenced by the AM(s) 166 is configured according to one or more operations indicated by the AM(s) 166. Additionally, or alternatively, the ASI 164 may include data that describes the function performed by the application according to the AM(s) 166. The ASI 164 may include different types of data. For example, the ASI 164 may include structured, semi-structured, and/or unstructured data. The ASI 164 may be extracted or inferred from documents retrieved from the data source(s) 104. In some examples, the ASI 164 may include data that is manually generated. The ASI 164 may be periodically updated, so that up-to-date search results and advertised search results can be provided in response to the users' search queries.

In some examples, the ASI 164 may include data that may be presented to the user when the application referenced by the AM(s) 166 is in the application state specified by the AM(s) 166. For example, the ASI 164 may include data that describes the application state of the application after the user device 102 has performed the one or more operations indicated by the AM(s) 166. In one example, if the function record 160 is associated with a shopping application, the ASI 164 may include data that describes a product (e.g., a name and a price) that is shown when the application is configured into the application state specified by the AM(s) 166. In another example, if the function record 160 is associated with a music player application, the ASI 164 may include data that describes a song (e.g., a name and an artist) that is played when the application is configured into the application state specified by the AM(s) 166.

The data included in the ASI 164 may depend on the type of information associated with the application state specified by the AM(s) 166. In one example, if the function record 160 is for an application that provides reviews of restaurants, the ASI 164 may include information (e.g., text and numbers) related to a restaurant, such as a category of the restaurant, reviews of the restaurant, and a menu for the restaurant. In this example, the AM(s) 166 may cause the user device 102 to launch the application and retrieve information for the restaurant using the application. As another example, if the function record 160 is for an application that plays music, the ASI 164 may include information related to a song, such as the name of the song, the artist, lyrics, and listener reviews. In this example, the AM(s) 166 may cause the user device 102 to launch the application and play the song described in the ASI 164 using the application.

Each of the AM(s) 166 may reference a web-based or native application and indicate one or more operations for the user device 102 to perform with respect to the referenced application, as described herein. Each of the AM(s) 166 may also include edition information that indicates the edition, or version, of the application referenced by the AM, as also described.

In some examples, the function record 160 may also include an application download address that indicates a location (e.g., a digital distribution platform) where a native application can be downloaded if the application is not installed on the user device 102. If a user selects a user selectable link that includes the application download address, the user device 102 may access the digital distribution platform from which the native application may be downloaded. The user device 102 may access the digital distribution platform using a web browser or another application (“GOOGLE PLAY®” by Google Inc.) included on the user device 102.

The function record 170 of FIG. 31) is a function record for an application state within OpenTable. OpenTable is a restaurant reservation application that allows users to search for restaurants and make restaurant reservations. OpenTable also provides information about restaurants, including descriptions of restaurants and user reviews for the restaurants. The function record 170 describes an application state in which OpenTable provides information for the restaurant “The French Laundry®.” In other words, the function record 170 describes an entry in OpenTable for The French Laundry.

The function record 170 includes a function ID “OpenTable—The French Laundry” 172, which may be used as a unique identifier to identify the function record 170 among other function records in the data store 118. In some examples, the function ID 172 may include a URL (e.g., the string “http://www.opentable.com/the-french-laundry”) that serves as the unique identifier. The user device 102 can use the URL to access an entry for The French Laundry in a web-based version of OpenTable. In other examples, the function ID 172 may be a string of one or more characters, numbers, or symbols that are not in human readable form.

The function record 170 also includes ASI 174. As shown in FIG. 3D, the ASI 174 includes data fields for a restaurant category, a restaurant description (i.e., a description of The French Laundry), user reviews, and additional data relating to The French Laundry. In this example, the data field for the restaurant category may include the text “French cuisine” or “contemporary.” The data field for the restaurant description may include text that describes The French Laundry. The data field for the user reviews may include text of user reviews for The French Laundry. The data field for the additional data may include additional data not applicable to the other data fields, e.g., a menu, prices, and operating hours for The French Laundry.

The function record 170 also includes one or more AMs 176. As described herein with respect to the AM(s) 166, each of the AM(s) 176 may reference OpenTable and indicate one or more operations to be performed by the user device 102 with respect to OpenTable. Using the AM(s) 176, the user device 102 may access the application state for The French Laundry within OpenTable. In some examples, the function record 170 may also include edition information that may indicate a version, or edition, of OpenTable associated with one or more of the AM(s) 176, i.e., indicate a particular edition of OpenTable for each of the AM(s) 176.

FIGS. 3E-3F depict other example function records that may be included in the data store 118 according to the present disclosure. FIG. 3E illustrates a general example of a function record 180 including data that is similar to that of the function record 160, namely a function ID 182, ASI 184, and one or more AMs 186. The function ID 182, ASI 184, and AM(s) 186 may serve similar functions as those of the function ID 162, ASI 164, and AM(s) 166 of the function record 160. The function record 180 also includes one or more entity IDs 188. FIG. 3F illustrates a specific example of a function record 190 for an application state (i.e., an entry for “The French Laundry”) within OpenTable. The function record 190 includes data that is similar to that of the function record 170, i.e., a function ID 192, ASI 194, and one or more AMs 196. As shown in FIG. 3F, the function record 190 also includes one or more entity IDs 198.

The function records 180 and 190 illustrate example techniques for generating ad records using entity records and function records. Specifically, the entity ID(s) 188 included in the function record 180 indicate one or more entity records associated with the function record 180. In this example, the entity ID(s) 188 correspond to one or more entity records included in the data store 128. As explained herein, each entity record included in the data store 128 includes an entity name, entity ID, entity category, and entity information that describe an entity associated with the entity record. In this manner, the entity ID(s) 188 indicate one or more entities associated with the function record 180, i.e., with the application state described by the function record 180. With reference to the function record 190, the entity ID(s) 198 may correspond to one or more entity records for entities associated with the entry for “The French Laundry” within OpenTable. An example entity specified by an entity record (i.e., by one of the entity ID(s) 198) associated with the function record 190 may be “The French Laundry.”

According to the disclosed techniques, the ad system 108 may receive an entity query from one of the advertiser devices 110. The ad system 108 may identify one or more AMs based on the entity query. For example, the ad system 108 may perform a search of the entity system 112 using the entity query and identify one or more entity records included in the data store 128 as a result of the search. For instance, the ad system 108 may identify entity records that each include an entity name, entity ID, entity category, and/or entity information that match terms of the entity query. The ad system 108 may identify one or more function records (e.g., the function record 180) included in the data store 118 that include entity IDs (e.g., the entity ID(s) 188) that correspond to the entity IDs of the identified entity records.

The ad system 108 may select one or more AMs from the identified function records and transmit the identified AMs to the advertiser device 110. The advertiser device 110 may display the identified AMs to the user of the advertiser device 110 using a GUI, e.g., as one or more selectable AMs. The ad system 108 may then receive one or more indications of selections of the identified AMs and one or more ad bid prices from the advertiser device 110. The ad system 108 may store the indications of the selections of the identified AMs and the ad bid prices received from the advertiser device 110 in an ad record (e.g., by generating a new ad record), thereby associating the selections and the ad bid prices.

FIG. 4A is a functional block diagram that illustrates example interactions between one of the user device(s) 102, one of the advertiser devices 110, the search system 100, the ad system 108, and the entity system 112. As described herein, the user device 102 transmits a search query 134 to the search module 114 of the search system 100. The search module 114 identifies one or more function IDs 146 using the search query 134 and the data store 118 of the search system 100, and transmits the function ID(s) 146 to the result generation module 116 of the search system 100. The result generation module 116 generates a search result set 148 (i.e., search results) using the function ID(s) 146, and transmits the search result set 148 to the user device 102. The search result set 148 may include one or more AMs selected from a first subset of function records specified by the function ID(s) 146.

The result generation module 116 also generates a remainder set 150 using the function ID(s) 146 and transmits the remainder set 150 to the ad generation module 120 of the ad system 108. In some examples, the remainder set 150 may include one or more AMs selected from a second subset of the function records specified by the function ID(s) 146. In other examples, the remainder set 150 may include one or more of the function ID(s) 146 that correspond to the second subset. In these examples, the ad system 108 may access the function records of the second subset using the remainder set 150, and select the AMs from the function records. The ad generation module 120 generates one or more entity links 178 (i.e., one or more advertised search results) using the remainder set 150, and transmits the entity link(s) 178 to the user device 102. The user device 102 displays the search result set 148 and the entity link(s) 178, e.g., to a user of the user device 102 that generated the search query 134.

To generate the entity link(s) 178 using the remainder set 150, the ad generation module 120 determines whether an AM included in the remainder set 150 (or corresponding to the remainder set 1150 via a function ID included in the set) is associated with one or more of a highest total ad bid price and a highest total ad bid number among the AMs included in the remainder set 150. The ad generation module 120 may make this determination using one or more ad records included in the data store 124 of the ad system 108. For example, the ad generation module 120 may determine that an AM included in, or corresponding to, the remainder set 150 is associated with the highest total ad bid price and/or number if the AM corresponds to a sponsored AM included in an ad record (e.g., if the ad record includes one or more indications of selections of the AM by advertisers) and if a total ad bid price and/or number stored in the ad record (or generated dynamically using data stored the ad record) is greater than a total ad bid price and/or number associated with any other AM included in the remainder set 150. The ad generation module 120 may generate an entity link 178 for the AM included in (or corresponding to) the remainder set 150 upon determining that the AM is associated with the highest total ad bid price and/or number (e.g., in instances where the AM is the only AM of the remainder set 150 that is associated with a total ad bid price and/or number).

To generate the ad record described above, a user (e.g., an advertiser) of one of the advertiser devices 110 submits an entity query to the ad system 108 via the advertiser device 110. The ad system 108 identifies one or more entity records included in the data store 128 using the entity query. The entity records are generated using the entity record generation module 126 of the entity system 112. The ad system 108 then identifies one or more AMs, including the sponsored AM, using the identified entity records. The ad system 108 transmits the identified AMs to the advertiser device 110 to be displayed to the user. The user then submits one or more selections of the AMs, including a selection of the sponsored AM, one or more ad bid prices associated with the selections, and, optionally, one or more additional parameters to the ad system 108 via the advertiser device 110. The entity query, the selections of the AMs, the ad bid prices, and the additional parameters may be referred to herein as ad data 200. The user may provide the ad data 200 to the ad system 108 via a GUI of the advertiser device 110, including one or more text fields, selection boxes, and/or other GUI elements. The ad record generation module 122 generates the ad record to include the selections of the AMs as one or more sponsored AMs of the ad record, and the ad bid prices. The ad record may also include any additional parameters provided by the user. The ad record generation module 122 stores the ad record in the data store 124. In sonic examples, rather that generating a new ad record, the ad record generation module 122 may update an existing ad record included in the data store 124. For example, the existing ad record may already include one or more other selections of the AMs and one or more ad bid prices associated with the other selections received by the ad system 108 from one or more users of other advertiser devices 110.

FIGS. 4B, 4C, and 4D illustrate example entity records 202, 212, and 222, respectively, that may be stored in the data store 128 of the entity system 112. The entity record 202 includes an entity name 204, an entity ID 206, an entity category 208, and entity information 210. The entity record 202 may generally represent data stored in the data store 128 that is related to an entity (e.g., a noun). The data store 128 may include data related to one or more different entities. Accordingly, the data store 128 may include one or more entity records each having a structure that is similar to that of the entity record 202, i.e., each having an entity name, an entity ID, an entity category, and/or entity information.

The entity name 204 may include one or more words, numbers, and/or symbols (e.g., punctuation marks). In some examples, the entity name 204 may denote a person, animal, place, thing, or idea. The entity ID 206 may identify the entity record 202 among other entity records included in the data store 128. For example, the entity ID 206 may uniquely identify the entity record 202. The entity ID 206 may be a string of alphabetic, numeric, and/or symbolic characters (e.g., punctuation marks) that uniquely identify the entity record 202.

The entity category 208 may indicate a category in which the data of the entity record 202 belongs. For example, the entity category 208 may indicate a category in which the entity name 204 and/or the entity information 210 belong. The entity category 208 may include one or more words (e.g., nouns), numbers, and/or symbols (e.g., punctuation marks).

The entity information 210 may represent data in the entity record 202 in addition to the entity name 204 and the entity category 208. In general, the entity information 210 may include any data that is associated with the entity name 204 and/or the entity category 208. In some examples, the data included in the entity information 210 may be associated with both the entity name 204 and the entity category 208. In other words, the data included in the entity information 210 may be related to the entity name 204 and described by the entity category 208.

The entity information 210 may include various types of data (e.g., structured, semi-structured, and/or unstructured data). Structured data in the entity information 210 may refer to data included in a defined data field. Semi-structured data in the entity information 210 may refer to data that, at a broad level, is associated with a data field, but is provided in an unstructured manner. Unstructured data in the entity information 210 may include data that is not specifically associated with a defined data field.

In some examples, the defined data fields of the entity record 202 may be tailored to the entity category 208 of the entity record 202. For example, entity records having a first entity category may include a first set of defined data fields associated with the first entity category. Entity records having a second entity category that is different than the first entity category may include a second set of defined data fields associated with the second entity category that are different than the first set of defined data fields. In other examples, the different entity records included in the data store 128 may have the same or similar defined data fields, even when the entity records include different entity categories.

In general, the entity information 210 may include any type of data related to an entity, including numbers or other statistics related to the entity, names, dates, text from websites, review articles, wiki articles, and/or other types of data. As one example, if the entity category 208 is “movie,” the entity information 210 may include data fields for actors, directors, producers, viewer reviews, and/or plot summaries. As another example, if the entity category 208 is “music,” the entity information 210 may include data fields for an artist's name, a track name, and a track length. As yet another example, if the entity category 208 is “book,” the entity information 210 may include data fields for an author's name, a publisher, and a publication date.

The example entity record 212 of FIG. 4C includes an entity name “The French Laundry” 214, an entity ID “#1” 216, an entity category “Restaurant” 218, and entity information 220. Thus, the entity record 212 represents an entity record for an entity “The French Laundry.” The example entity record 222 of FIG. 4D includes data that is similar to that of the entity record 212. Specifically, the entity record 222 includes an entity name “The French Laundry” 224, an entity ID “#1” 226, an entity category “Restaurant” 228, and entity information 230. The entity category 228 includes an optional entity subcategory field, which may include data that describes a subcategory of the category “Restaurant,” e.g., “French cuisine.” The entity record 222 also includes one or more optional AMs 232, each of which may be the same or similar to the AM(s) 166 described herein with reference to the function record 160. For example, each of the AM(s) 232 may specify an application state of a web-based or native application by including a reference to the application and indicating one or more operations for the application to perform.

FIGS. 4E, 4F, and 4G illustrate example ad records 234, 234, and 254, respectively, that may be included in the data store 124 of the ad system 108. An ad record may include a variety of different types of data related to an advertisement. For example, as shown in FIG. 4E, the ad record 234 includes an ad record name/ID 236, one or more sponsored AMs 238, ad content 240, and entity bid data 242. As shown in FIG. 4E, the entity bid data 242 may include one or more entries that each specify data associated with an advertiser's bid (i.e., “bid 1 data 242-1 . . . bid N data 242-N”). Each entry specifying data associated with an advertiser's bid may include an indication of a selection of one of the AM(s) 238 by an advertiser and an ad bid price (e.g., an indication of the ad bid price) associated with the selection. In other words, each entry may include a name of (i.e., reference) the advertiser (e.g., “advertiser 1”) and the ad bid price (e.g., “bid amount 1”) specified by the advertiser for advertising the one of the AM(s) 238. In general, the ad record 234 may represent data stored in the data store 124 that is related to an advertisement. The data store 124 may include one or more other ad records each having a structure that is similar to that of the ad record 234, i.e., each including an ad record name/ID, sponsored AM(s), ad content, and entity bid data.

The ad record name/ID 236 identifies the ad record 234 among other ad records included in the data store 124. For example, the ad record name/ID 236 may uniquely identify the ad record 234. The ad record name/ID 236 may be a string of alphabetic, numeric, and/or symbolic characters (e.g., punctuation marks) that uniquely identify the ad record 234. In some examples, an advertiser may generate the ad record name/ID 236. In these examples, the advertiser may then access and update the ad record 234 using the ad record name/ID 236,

The AM(s) 238 correspond to one or more sponsored application states of one or more web-based or native applications associated with the ad record 234. As described herein, the ad content 240 and the entity bid data 242 may be used to generate advertisements for the AM(s) 238. Each of the AM(s) 238 may be the same as, or similar to, the AM(s) 166 described herein with reference to the function record 160. For example, each of the AM(s) 238 may specify an application state of a web-based or native application by including a reference to the application and indicating one or more operations for the application to perform. The AM(s) 238 may be associated with the ad record 234 included in the data store 124 and one or more function records the function record 160) included in the data store 118. For example, a function record included in the data store 118 may also include one or more of the AM(s) 238. In some examples, the AM(s) 238 may correspond to (e.g., be generated based on) one or more selections of AMs received by the ad system 108 from one or more advertisers using one or more of the advertiser devices 110, as described herein. For example, the AMs may have been displayed to the advertisers in response to the advertisers submitting entity queries to the ad system 108. As described herein, the ad content 240 and the entity bid data 242 may also correspond to one or more inputs from the advertisers received by the ad system 108 via the advertiser devices 110.

The ad record 244 shown in FIG. 4F includes an ad record name/ID 246, one or more sponsored AMs 248, and ad content 250, which are analogous to the ad record name/ID 236, AM(s) 238, and ad content 240 described above with reference to the ad record 234. As shown in FIG. 4F, the entity bid data 252 included in the ad record 244 includes one or more of a cumulative bid amount (e.g., a total ad bid price), a cumulative bid number (e.g., a total ad bid number), and other aggregated bid data associated with the ad record 244. The cumulative bid amount may represent a sum of ad bid prices received from one or more advertisers who included a particular one of the AM(s) 248 in the advertisers' advertisement bids via one or more of the advertiser devices 110. The cumulative bid number may represent a number of all ad bid prices received from the advertisers, or a number of all indications of selections of the particular one of the AM(s) 248 received from the advertisers via the advertiser devices 110. The other aggregated bid data may represent any combination of (e.g., using one or more algebraic operations) the ad bid prices, the indications of the selections of the particular one of the AM(s) 248, as well as any other data received from the advertisers via the advertiser devices 110. In some examples, the entity bid data 252 may also include one or more entries that specify the indications of the selections of the particular one of the AM(s) 248 and the ad bid prices associated with the selections, in a similar manner as described above with reference to the ad record 234. The ad record 244 may include a cumulative bid amount, a cumulative bid number, other aggregated bid data, and/or one or more indications of selections of an AM and one or more ad bid prices associated with the selections for each of one or more of the AM(s) 248.

The ad record 254 shown in FIG. 4G includes an ad record name “Advertisement for OpenTable—The French Laundry” having an ID “ID#1” 256, The ad record 254 also includes a sponsored AM “OpenTable The French Laundry” 258. In this example, the application associated with the ad record 254 is OpenTable. The sponsored AM 258 associated with the ad record 254 is an entry in OpenTable for The French Laundry. As such, the ad record 254 is an ad record for the application state, or entry, within OpenTable for The French Laundry. In this example, the data store 118 may include a function record that includes an AM that specifies the application state, or entry, within OpenTable for The French Laundry. For example, with reference to FIG. 3D, the data store 118 may include the function record 170 having the function ID “OpenTable—The French Laundry” 172 and AM(s) 176, one or more of which may correspond to the sponsored AM 258 of the ad record 254. As such, the function record 170 and the ad record 254 may both include the sponsored AM 258 or its equivalent.

As shown in FIG. 4G, the entity bid data 262 included in the ad record 254 includes one or more of a cumulative bid amount, a cumulative bid number, and other aggregated bid data associated with the ad record 254. As also shown, the entity bid data 262 may further include one or more entries (i.e., “bid 1 data 262-1 . . . bid N data 262-N”) that each specify an indication of a selection of the AM 258 and an ad bid price associated with the selection received from one of the advertiser devices 110, as described above with reference to the ad records 234 and 244. The entity bid data 262 may also include one or more additional parameters, e.g., including budget, timing, user, and/or platform parameters. The budget parameters may define one or more budgets associated with advertising the AM 258. The timing parameters may define start and stop dates for advertising the AM 258, and/or time(s) of day during which the AM 258 is to be advertised. The user and/or platform parameters may specify one or more user, device, and/or platform (e.g., OS) types for which the sponsored AM 258 is to be advertised.

Referring back to FIG. 4E, the ad content 240 may include data that is used by the ad system 108 (e.g., by the ad generation module 120) to generate one or more advertised search results based on the AM(s) 238. For example, the ad system 108 may use link data associated with the AM(s) 238 and the ad content 240 to generate one or more user selectable links for some or all of the AM(s) 238. For instance, the ad system 108 may generate an advertised search result (e.g., a user selectable link) for one of the AM(s) 238 in the event the ad system 108 receives the AM from the search system 100 and determines that the AM is associated with a highest total ad bid price and/or number, as indicated by the entity bid data 242. In some examples, the ad content 240 may include text and/or image data (e.g., “SPONSORED,” or “AD”) that, when incorporated into the user selectable link, indicates to the user that the user selectable link is for an advertised search result. In this example, each of the ad content 250 and 260 may serve a similar function as that of the ad content 240 described above.

As described herein, the entity bid data 242 may specify when the ad system 108 (e.g., the ad generation module 120) generates an advertisement for one or more of the AM(s) 238. For example, the entity bid data 242 may specify a total ad bid price and/or number (or, e.g., a value of another cumulative ad bid parameter) that is associated with each of one or more of the AM(s) 238. The ad system 108 may generate an advertised search result based on each of one or more of the AM(s) 238 when the ad system 108 receives the AM from the search system 100 and determines that the AM is associated with a highest total ad bid price and/or number (or, e.g., a value of the other parameter) based on the entity bid data 242. The entity bid data 242 may also specify other advertising parameters, as described with reference to FIG. 4G.

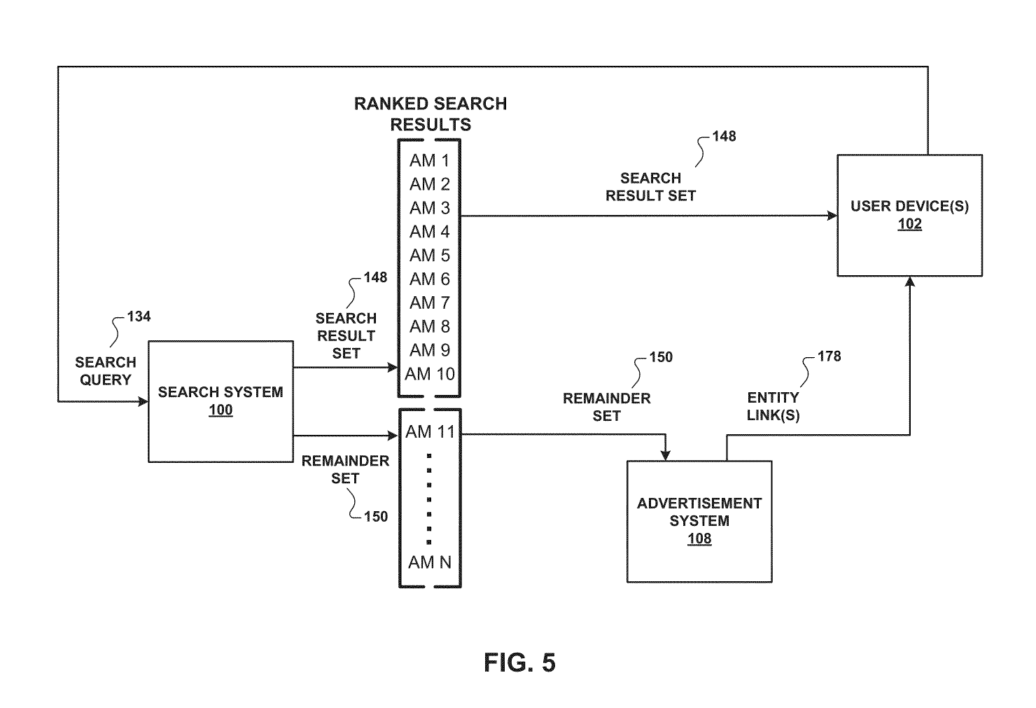

FIG. 5 is a data flow diagram that illustrates an example flow of data among the search system 100, the ad system 108, and one of the user device(s) 102. As shown in FIG, the search system 100 receives a search query 134 from one of the user device(s) 102. As described herein, the search query 134 may be included in a query wrapper (not shown). As also shown, the search system 100 identifies multiple AMs (“AM1-AMN”) based on the search query 134. For example, the search system 100 may perform a search of the data store 118 using the search query 134, and identify one or more function records during the search. In this example, the search system 100 may select the AM1-AMN from the identified function records.

In the example of FIG. 5, the AM1-AM10 are included in the search result set 148, and the AM11-AMN are included in the remainder set 150. In this example, N represents an integer value that is greater than or equal to 11. The AM1-AM10 of the search result set 148 may represent search results that are transmitted by the search system 100 to the user device 102. For example, the AM1-AM10 may correspond to the highest ranked (e.g., most relevant to the search query 134) function records identified during the search. The AM11-AMN of the remainder set 150 may represent one or more AMs that may be used by the ad system 108 to generate one or more advertised search results that are transmitted to the user device 102. In some examples, the AM11-AMN may correspond to relatively lower ranked (e.g., less relevant to the search query 134) function records identified during the search compared to the AM1-AM10. As one example, the AM11-AMN may correspond to one or more function records that each fall below a specified relevance threshold. In this example, the AM1-AM10 meet or exceed the threshold. As another example, the AM11-AMN may correspond to one or more function records that are not included within a predetermined number of the most relevant function records identified based on the search query 134. In this example, the AM1-AM10 are included within the predetermined number. In other examples, the AM1-AM10 and the AM11-AMN may correspond to other groupings of the function records identified based on the search query 134.

As shown in FIG. 5, the search system 100 transmits the search result set 148 (i.e., the search results) to the user device 102. The search system 100 also transmits the remainder set 150 to the ad system 108. The ad system 108 determines whether an AM included in the remainder set 150 is associated with one or more of a highest total ad bid price and a highest total ad bid number among the one or more AMs included in the remainder set 150, as described herein. For example, the ad system 108 may first determine whether any of the AM11-AMN included in the remainder set 150 are also included in an advertiser's bid. In this example, the ad system 108 may determine whether any of the AM11-AMN are included in an advertiser's bid by determining whether any of the AM11-AMN are referenced in an ad record. As explained herein, an AM may be referenced in an ad record using one or more indications of selections of the AM stored in the ad record. As also explained herein, each indication of the selection of the AM may be generated by an advertiser device as a result of an advertiser including the AM in the advertiser's bid. In this manner, to determine whether any of the AM11-AMN are included in an advertiser's bid, the ad system 108 may determine whether an ad record includes stored therein an indication of a selection of any of the AM11-AMN.

The ad system 108 may further determine whether any AM among those of the AM11-AMN that are included in an advertiser's bid, if any, is associated with the highest total ad bid price and/or number. For example, to make this determination, the ad system 108 may compare one or more of total ad bid prices and total ad bid numbers associated with those of the AM11-AMN that are included in an advertiser's bid. As explained herein, a total ad bid price and/or number associated with each of those of the AM11-AMN that are included in an advertiser's bid may be computed using information stored in the ad record that includes the indication of the selection of the AM. For example, the total ad bid price may be computed by summing all ad bid prices stored in the ad record. Furthermore, the total ad bid number may be computed by determining one of a number of all indications of selections of the AM and a number of all ad hid prices stored in the ad record. As such, to determine whether any AM among those of the AM11-AMN that are included in an advertiser's bid is associated with the highest total ad bid price and/or number, the ad system 1108 may compute a total ad bid price and/or number for each of the AM11-AMN that are included in an advertiser's bid using one or more ad hid prices and selections of the AM stored in the corresponding ad record. The ad system 108 may then compare the one or more total ad bid prices and/or numbers generated for those of the AM11-AMN that are included in an advertiser's hid to determine whether any one of the AM11-AMN that are included in an advertiser's bid is associated with the highest total ad bid price and/or number. In examples where only one of the AM11-AMN is included in an advertiser's bid, the ad system 108 may determine that the AM is associated with the highest total ad bid price and/or number, as described herein.

In other examples, the ad system 1108 may determine whether an AM included in the remainder set 150 is associated with a highest value of another cumulative ad bid parameter among the one or more AMs included in the remainder set 150, as described herein. In any case, in the event an AM included in the remainder set 150 is associated with the highest total ad bid price and/or number (or, e.g., with a highest value of another cumulative ad bid parameter), the ad system 108 may transmit the AM as one of the entity link(s) 178 (i.e., as an advertised search result) to the user device 102. As explained herein, the ad system 108 may make the above-described determination and generate an advertised search result for each of multiple ones of the AMs included in the remainder set 150. For example, the ad system 108 may determine that each of the multiple AMs is associated with a relatively higher total ad hid price and/or number (or, e.g., a relatively higher value of another cumulative ad bid parameter) compared to a total ad bid price and/or number (or, e.g., a value of another cumulative ad hid parameter) associated with each of one or more other AMs included in the remainder set 150. The ad system 108 may then generate multiple advertised search results based on the multiple AMs.

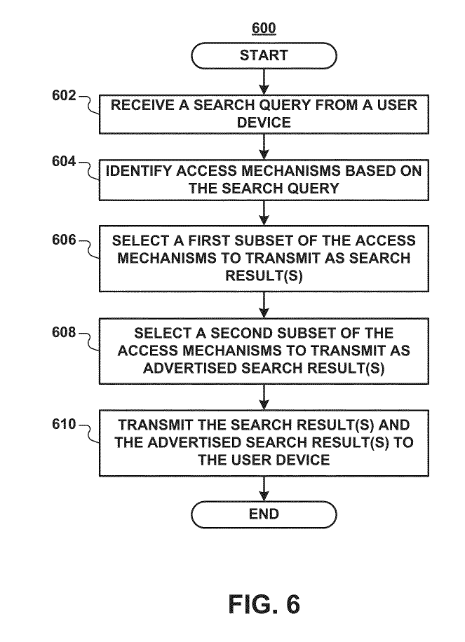

FIG. 6 illustrates an example method 600 of identifying AMs (e.g., the AM(s) 166) based on a search query (e.g., the search query 134) and generating search results (e.g., the search result set 148) and advertised search results (e.g., the entity link(s) 178) using the identified AMs. In block 602, the search system 100 receives a search query 134 from one of the user device(s) 102. For example, the user device 102 may have received the search query 134 from a user of the user device 102. In block 604, the search system 100 identifies one or more AMs based on the received search query 134. For example, the search system 100 (e.g., the search module 114) may identify one or more function records (e.g., one or more function IDs of the function records) included in the data store 118 based on the search query 134, and select the AMs from the identified function records.

In block 606, the search system 100 (e.g., the result generation module 116) selects a first subset of the identified AMs to transmit as one or more search results (e.g., the search result set 148) to the user device 102. In other words, in block 606, the search system 100 generates the search results based on the first subset. In block 608, the search system 100 (e.g., the result generation module 116) selects a second subset of the identified AMs to potentially transmit as one or more advertised search results (e.g., the entity link(s) 178) to the user device 102. The first and second subsets may each include or more of the identified AMs. The first and second subsets may also be mutually exclusive, or may each include one or more common AMs of the identified AMs. The first and second subsets may further correspond to all or a subset of the identified AMs. The search system 100 may transmit the second subset to the ad system 108. The ad system 108 may determine whether an AM included in the second subset is associated with one or more of a highest total ad bid price and a highest total ad bid number among the one or more AMs included in the second subset, as described herein. In the event an AM included in the second subset is associated with the highest total ad bid price and/or number, the ad system 108 may generate an advertised search result based on the AM. In the event an AM included in the second subset is not associated with the highest total ad hid price and/or number, the ad system 108 may refrain from generating an advertised search result based on the AM.

In some examples, the ad system 108 may make the above-described determination and generate an advertised search result for each of multiple ones of the AMs included in the second subset. For example, the ad system 108 may determine that each of multiple AMs included in the second subset is associated with a relatively higher ad bid price and/or number compared to an ad bid price and/or number associated with each of one or more other AMs included in the second subset. The ad system 108 may then generate multiple advertised search results based on the multiple AMs. In other examples, the ad system 108 may determine whether an AM included in the second subset is associated with a highest value of another cumulative ad bid parameter among the one or more AMs included in the second subset, as also described herein. For example, a value of the other cumulative ad bid parameter associated with an AM included in the second subset may represent any of the following: (1) a number of all indications of selections of the AM stored in an ad record multiplied by a sum of all advertisement bid prices associated with the selections also stored in the ad record; (2) the number of all indications of selections of the AM added to the sum of all advertisement bid prices; (3) an average of all advertisement bid prices associated with the selections; (4) the average of all advertisement bid prices multiplied by the number of all indications of selections of the AM; and (5) the average of all advertisement bid prices added to the number of all indications of selections of the AM. In the event an AM included in the second subset is associated with the highest value of the other cumulative ad bid parameter (e.g., of any of the example parameters described above), the ad system 108 may generate an advertised search result based on the AM. In the event an AM included in the second subset is not associated with the highest value of the parameter, the ad system 108 may refrain from generating an advertised search result based on the AM. In some examples, the ad system 108 may also make the above-described determination and generate an advertised search result for each of multiple AMs included in the second subset.

In block 610, the search system 100 and/or the ad system 108 transmits the search results including the first subset, and, when applicable, the one or more advertised search results including one or more AMs of the second subset, to the user device 102 that generated the search query 134. As explained herein, the search system 100 and the ad system 108 may also transmit link data and ad content to the user device 102 along with the search results and the advertised search results. As also explained, the user device 102 may use the link data and the ad content to generate one or more user selectable links for the AMs of the search results and the advertised search results. The user device 102 may then display the user selectable links to the user.

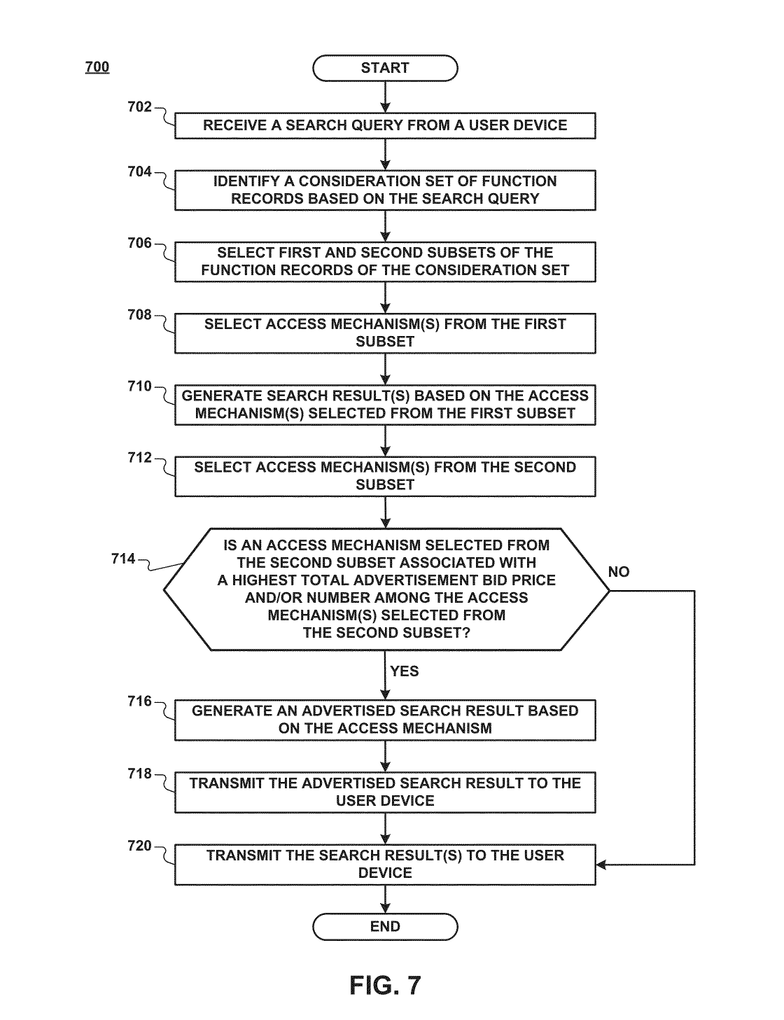

FIG. 7 illustrates an example method 700 of performing a search for AMs (e.g., the 166) based on a search query (e.g., the search query 134) and generating search results (e.g., the search result set 148) and advertised search results (e.g., the entity link(s) 178) using the AMs. In block 702, the query analysis module 152 receives a search query 134 from one of the user device(s) 102. In some examples, the query analysis module 152 may perform an analysis of the search query 134, as described herein. In block 704, the set generation module 154 identifies a consideration set 158 of one or more function records included in the data store 118 based on the search query 134. In some examples, the set processing module 156 may process (e.g., score) the consideration set 158, as also described herein.

In block 706, the result generation module 116 selects first and second subsets of the function records included in the consideration set 158. For example, the result generation module 116 may select the first and second subsets of the function records based on the result scores associated with the function records. As one example, the result generation module 116 may select one or more function records in the consideration set 158 that have the highest result scores as the first subset. In this example, the result generation module 116 may select some or all of the remaining function records in the consideration set 158 as the second subset. As another example, the result generation module 116 may select the first and second subsets such that they include at least one common function record of the consideration set 158.

In block 708, the result generation module 116 selects one or more AMs from the first subset of the function records. In block 710, the result generation module 116 generates search results (e.g., the search result set 148) based on the AMs selected from the first subset. In this example, the search results include the selected AMs. As described herein, the search results may also include the result scores associated with the function records from which the AMs were selected, and/or link data (e.g., text and/or image data) for each selected AM.

In block 712, the result generation module 116 selects one or more AMs from the second subset of the function records. In this example, the result generation module 116 may transmit the selected AMs to the ad system 108. In block 714, the ad system 108 determines whether an AM selected from the second subset is associated with one or more of a highest total ad bid price and a highest total ad bid number compared to all other AMs selected from the second subset, as described herein. In the event an AM selected from the second subset is associated with the highest total ad bid price and/or number, the method 700 proceeds to blocks 716, 718, and 720. In block 716, the ad system 108 generates an advertised search result based on the AM selected from the second subset that is associated with the highest total ad bid price and/or number. In block 718, the ad system 108 transmits the advertised search result, including the selected AM associated with the highest total ad bid price and/or number, to the user device 102 that generated the search query 134. As described herein, the advertised search result may also include link and/or ad content (e.g., text and/or image data) associated with the selected AM. In block 720, the result generation module 116 transmits the search results, including the AMs selected from the first subset, to the user device 102. Alternatively, in the event an AM selected from the second subset is not associated with the highest total ad bid price and/or number, the method 700 proceeds from block 714 directly to block 720.

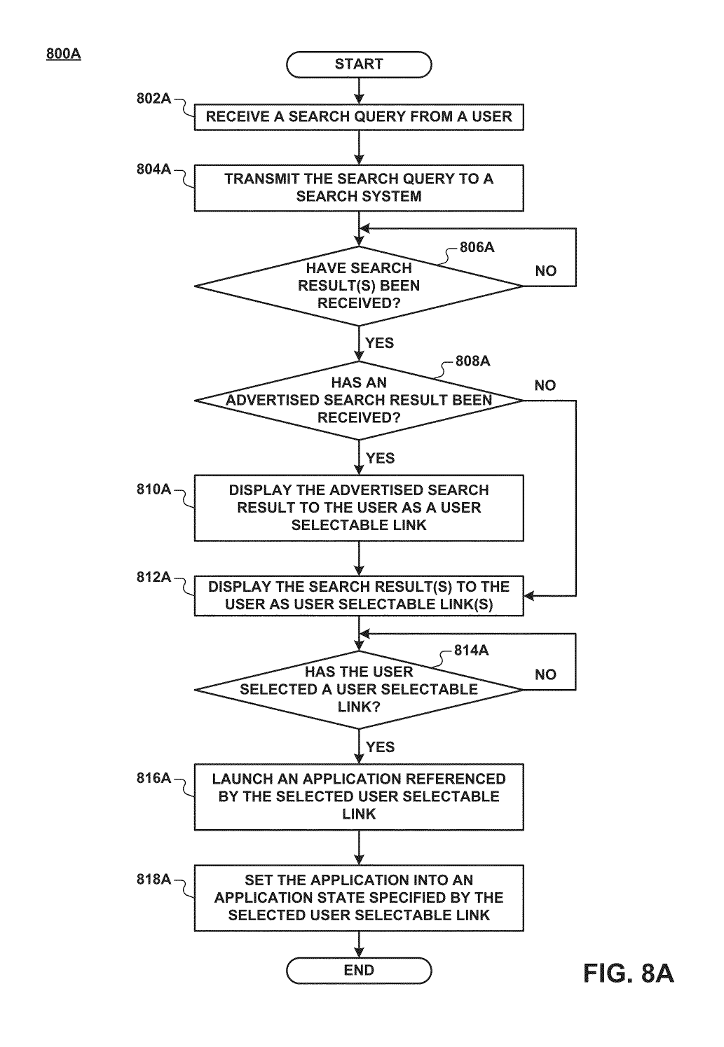

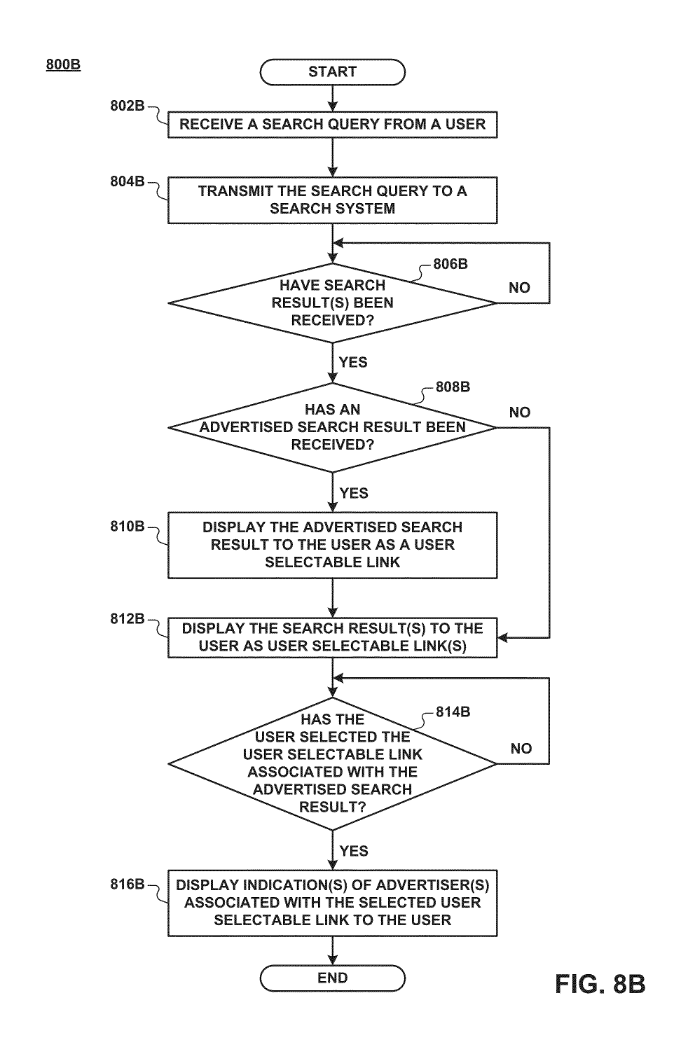

FIG. 8A illustrates an example method 800A of receiving AMs (e.g., the AM(s) 166) as search results (e.g., the search result set 148) and advertised search results (e.g., the entity link(s) 178) at a user device (e.g., one of the user device(s) 102). The user device 102 described with reference to the method 800A may include a search application (e.g., a web-based or native application) that is configured to receive user inputs and communicate with the search system 100 and/or the ad system 108. The search application may generate a GUI that receives search queries (e.g., the search query 134) from users of the user device 102 and displays search results (e.g., the search result set 148) and advertised search results (e.g., the entity link(s) 178) received from the search system 100 and/or the ad system 108 in response to the search queries.

In block 802A, one of the user device(s) 102 receives a search query 134 from a user of the user device 102. For example, the user may have entered the search query 134 into the GUI (e.g., into a search field of the GUI) of the search application. In block 804A, the user device 102 transmits the search query 134 to the search system 100. For example, the user may have caused the user device 102 to transmit the search query 134 to the search system 100 (e.g., by selecting a search button of the GUI). In block 806A, the user device 102 waits to receive one or more search results (e.g., the search result set 148) that are responsive to the search query 134 from the search system 100. In this example, the search results include one or more AMs that each specify an application state of an application. The method 800A proceeds from block 806A to block 808A when the user device 102 receives the search results.

In block 808A, the user device 102 waits to receive an advertised search result (e.g., one of the entity link(s) 178) from the ad system 108. For example, the search system 100 may have transmitted one or more AMs that are responsive to the search query 134 to the ad system 108. In some examples, the AMs transmitted by the search system 100 to the ad system 108 may be relatively less relevant to the search query 134 (e.g., associated with relatively lower result scores) compared to the AMs transmitted by the search system 100 to the user device 102. The ad system 108 may determine that one of the AMs transmitted by the search system 100 to the ad system 108 is associated with one or more of a highest total ad bid price and a highest total ad bid number compared to all other AMs transmitted by the search system 100 to the ad system 108, as described herein. Based on this determination, the ad system 108 may transmit the advertised search result, including the AM associated with the highest total ad bid price and/or number, to the user device 102. In the event the user device 102 receives the advertised search result from the ad system 108, the method 800A proceeds to block 810A, and then to block 812A. Alternatively, in the event the user device 102 does not receive the advertised search result from the ad system 108, the method 800A proceeds directly to block 812A.

Specifically, in the event the user device 102 receives the advertised search result, in block 810A, the user device 102 displays the advertised search result, including the AM received by the user device 102 from the ad system 108, to the user as a user selectable link. In block 812A, the user device 102 also displays the search results, including the AMs received by the user device 102 from the search system 100, to the user as one or more user selectable links. For example, the search application may display the advertised search result and the search results to the user as the user selectable links via the GUI of the search application. As explained herein, the search application may generate the user selectable links for the AMs received by the user device 102 from the ad system 108 and the search system 100, e.g., using link data and/or ad content associated with the AMs and also received by the user device 102. Alternatively, in the event the user device 102 does not receive the advertised search result, the user device 102 does not display the advertised search result to the user. Instead, in block 812A, the user device 102 displays the search results to the user as the one or more user selectable links.

In block 814A, the user device 102 waits to receive a selection of one of the user selectable links (e.g., generated for an AM received by the user device 102 from the search system 100 or the ad system 108) from the user. The method 800A proceeds from block 814A to block 816A when the user device 102 receives the selection of the user selectable link from the user. In block 816A, the user device 102 launches the application specified by an AM associated with the user selectable link selected by the user. In block 818A, the user device 102 sets the application into the application state specified by the AM.

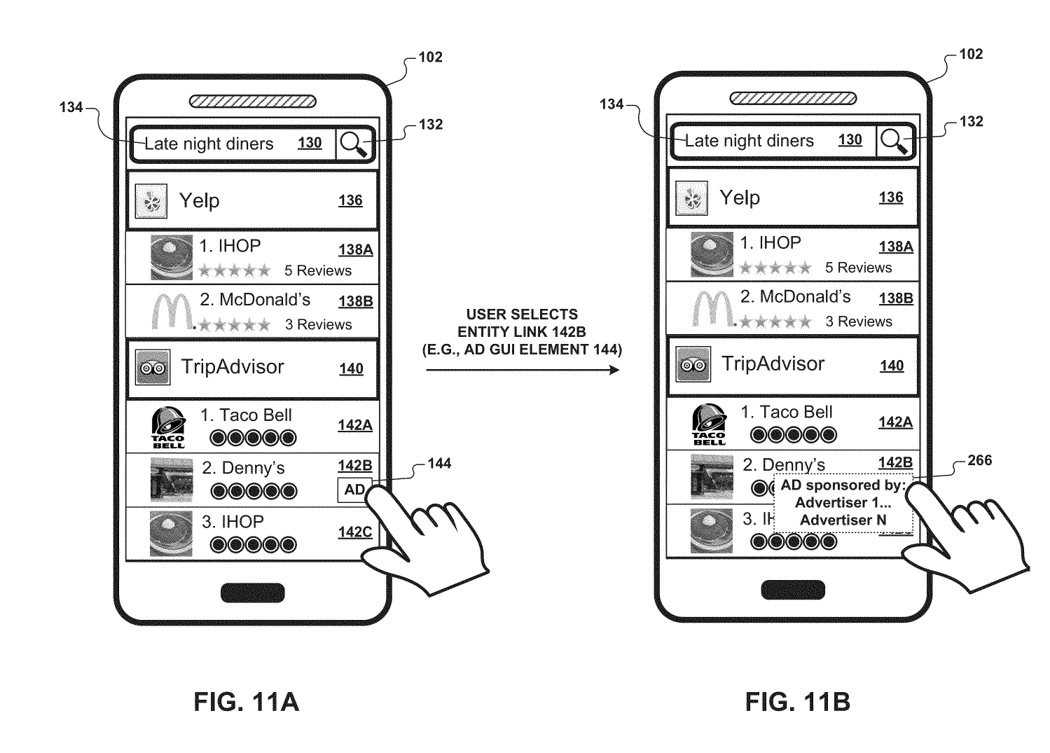

FIG. 8B illustrates another example method 800B of receiving AMs as search results and advertised search results at a user device. Blocks 802B-812B of the method 800B are analogous to blocks 802A-812A of the example method 800A described above with reference to FIG. 8A. In contrast to the method 800A, in block 814B, the user device 102 waits to receive a selection of the user selectable link associated with the advertised search result from the user. In other words, in block 814B, the user device 102 waits to receive a selection of the user selectable link generated for the AM received by the user device 102 from the ad system 108. In block 816B, in response to receiving the selection of the user selectable link, the user device 102 displays an indication of each of one or more advertisers associated with the selected user selectable link to the user. In this example, each of the advertisers may have included the AM used to generate the selected user selectable link in the advertiser's advertisement bid, as described herein. For example, each advertiser may have selected the AM from among one or more AMs responsive to the advertiser's entity query, and specified an entity bid amount value (e.g., an ad bid price) to be associated with the AM in an ad record. An example of a user device 102 displaying indications of advertisers associated with a selected user selectable link used to display an advertised search result is described with respect to FIGS. 11A-11B.

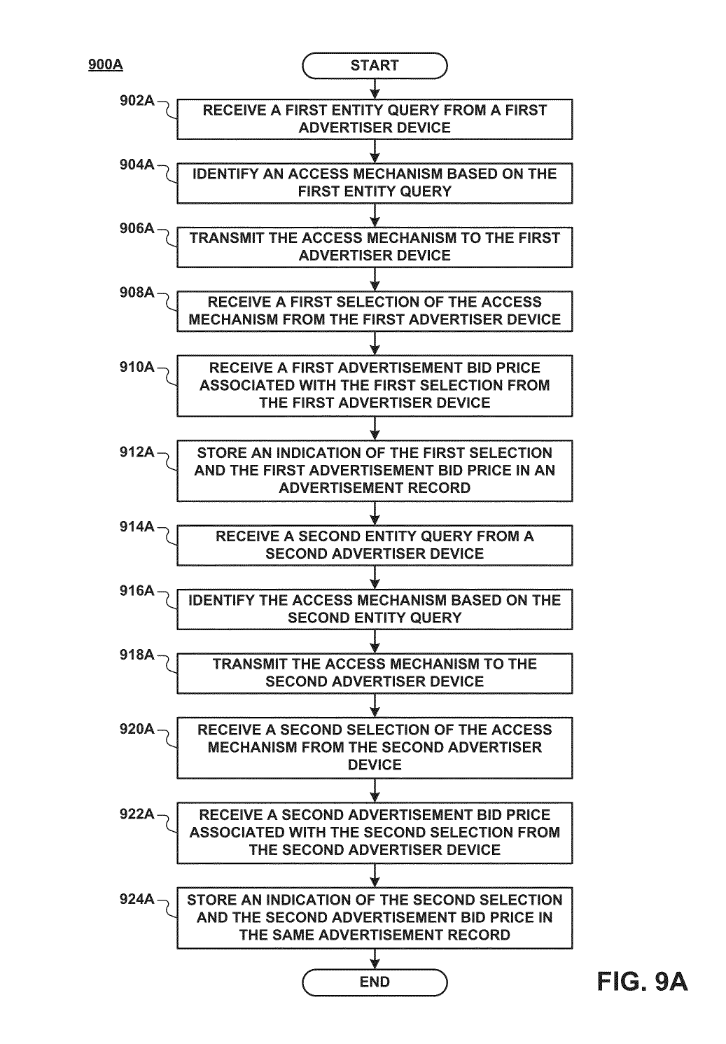

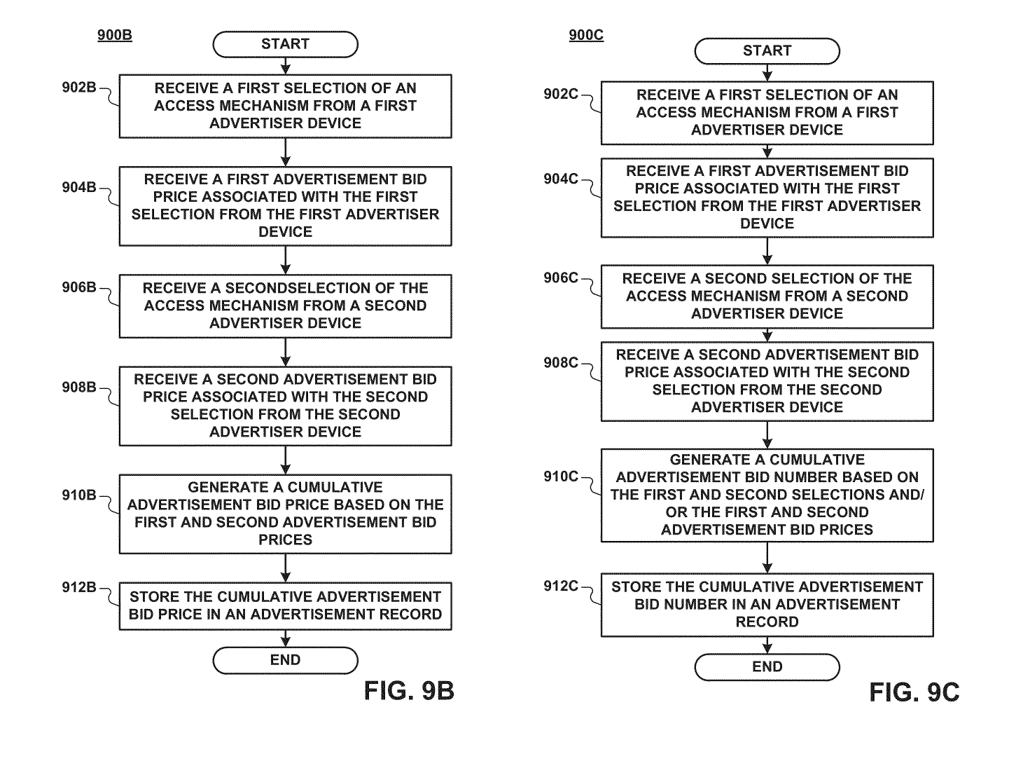

FIG. 9A illustrates an example method 900A of bidding on an AM (e.g., one of the AM(s) 166) associated with an entity (e.g., the entity name 204) at each of multiple advertiser devices (e.g., multiple ones of the advertiser devices 110). The multiple advertiser devices 110 described with reference to the method 900A may each include a bidding application (e.g., a web-based or native application) that is configured to receive user inputs and communicate with the ad system 108 and/or the entity system 112. The bidding application may generate a GUI that receives entity queries (e.g., the entity query 274 depicted in FIG. 12) from users (e.g., advertisers) of the corresponding advertiser device 110 and displays AMs (e.g., the AM(s) 166) received from the ad system 108 and/or the entity system 112 in response to the entity queries. The bidding application may also receive selections of the displayed AMs, ad hid prices associated with the selections, and other parameters, from the users.

In block 902A, the ad system 108 receives a first entity query (e.g., the entity query 274) from a first one of the advertiser devices 110. For example, a user (e.g., an advertiser) of the first advertiser device 110 may have entered the first entity query into a search field (e.g., the entity search field 270 depicted in FIG. 12) of the GUI of the bidding application and caused the first advertiser device 110 to submit the first entity query to the ad system 108. In block 904A, the ad system 108 identifies an AM based on the first entity query. For example, the ad system 108 may perform a search of the entity system 112 (e.g., the data store 128) using the first entity query and identify one or more entity records (e.g., the entity record 202) during the search. In this example, the ad system 108 may identify one or more entity records that each include an entity name, an entity ID, an entity category, and/or entity information that match one or more terms of the first entity query. As one example, the ad system 108 may select one or more AMs, including the identified AM, from the identified entity records. As another example, the ad system 108 may identify one or more function records using the identified entity records, and select the AMs from the identified function records. For example, the ad system 108 may identify one or more function records that reference the identified entity records, e.g., that include one or more entity IDs of the identified entity records. Alternatively, the ad system 108 may identify one or more function records that each include one or more terms (e.g., in the function ID and/or ASI) that match one or more terms of the identified entity records.

In block 906A, the ad system 108 transmits the identified AM to the first advertiser device 110. The ad system 108 may also transmit one or more other AMs selected from identified entity records or identified function records to the first advertiser device 110, as described herein. In some examples, the first advertiser device 110 may display the identified AM (e.g., along with the one or more other AMs) to the user via the GUI of the bidding application, as described with reference to FIG. 12. For example, the first advertiser device 110 may display the identified AM to the user as an advertiser selectable AM (hereinafter, “selectable AM”). In some examples, the ad system 108 may transmit additional information to the first advertiser device 110 along with the identified AM, such as text and/or image data that the first advertiser device 110 may use to generate the selectable AM.

In block 908A, the ad system 108 receives a first selection of the identified AM from the first advertiser device 110. For example, the user may select (e.g., touch, or click on) the selectable AM used to display the identified AM to the user. In block 910A, the ad system 108 also receives a first ad bid price associated with the first selection from the first advertiser device 110. For example, the user may specify the first ad bid price via the GUI of the bidding application. In block 912A, the ad system 108 stores an indication of the first selection and the first ad bid price in an ad record (e.g., the ad record 234). As described herein, in some examples, the ad system 108 may generate a new ad record and store the indication of the first selection and the first ad bid price in the new ad record. For example, the ad system 108 may store the new ad record in the data store 124, e.g., along with one or more other ad records. In other examples, the ad system 108 may update an existing ad record using the indication of the first selection and the first ad bid price, as also described herein. The ad system 108 may also receive one or more additional parameters from the first advertiser device 110, e.g., one or more user, platform, timing, and/or budget parameters. The ad system 108 may store the additional parameters in the ad record with the indications of the first selection and the first ad bid price.

In block 914A, the ad system 108 receives a second entity query from a second one of the advertiser devices 110, in a similar manner as described above with reference to block 902A. In block 916A, the ad system 108 identifies the same AM based on the second entity query. In other words, the ad system 108 identifies one or more AMs, including the AM previously identified by the ad system 108 using the first entity query, using the second entity query. In this example, the ad system 108 may identify the AM (e.g., along with the one or more other AMs) based on the second entity query in a similar manner as described above with reference to block 904A. In block 918A, the ad system 108 transmits the identified AM (e.g., along with the one or more other AMs) to the second advertiser device 110. In some examples, the second advertiser device 110 may display the identified AM (e.g., along with the one or more other AMs) to the user via the GUI of the bidding application. For example, the ad system 108 may display the identified AM to the user as a selectable AM. In some examples, the ad system 108 may transmit additional information to the second advertiser device 110 along with the identified AM, such as text and/or image data that the second advertiser device 110 may use to generate the selectable AM, in a similar manner as described above.

In block 920A, the ad system 108 receives a second selection of the identified AM from the second advertiser device 110, in a similar manner as described above with reference to block 908A. In block 922A, the ad system 108 also receives a second ad bid price associated with the second selection from the second advertiser device 110, in a similar manner as described above with reference to block 910A. In block 924A, the ad system 108 stores an indication of the second selection and the second ad bid price in the same ad record. In other words, the ad system 108 updates the existing ad record that includes the indication of the first selection and the first bid price to also include the indication of the second selection and the second ad bid price. In some examples, the ad system 108 may receive one or more additional parameters from the second advertiser device 110, e.g., one or more user, platform, and/or budget parameters, in a similar manner as described above. The ad system 108 may store the additional parameters in the ad record with the indications of the first and second selections and the first and second ad bid prices.

FIG. 9B-9C illustrate other example methods 900B and 900C, respectively, of bidding on an AM (e.g., one of the AM(s) 166) associated with an entity (e.g., the entity name 204) at each of multiple advertiser devices (e.g., multiple ones of the advertiser devices 110). The advertiser devices 110 described with reference to the methods 900B and 900C may each include a bidding application (e.g., a web-based or native application) that is configured to receive user inputs and communicate with the ad system 108 and/or the entity system 112. The bidding application may generate a GUI that receives entity queries (e.g., the entity query 274) from users (e.g., advertisers) of the corresponding advertiser device 110 and displays AMs (e.g., the AM(s) 166) received from the ad system 108 and/or the entity system 112 in response to the entity queries. The bidding application may also receive selections of the displayed AMs, ad bid prices associated with the selections, and other parameters, from the users. In each of the methods 900B and 900C, the ad system 108 has received an entity query from each of multiple ones of the advertiser devices 110, identified one or more AMs based on each entity query, and transmitted the identified AMs to the corresponding ones of the advertiser devices 110. Upon receiving the corresponding one or more of the identified AMs, each of the advertiser devices 110 has displayed the AMs to a user of the advertiser device 110.

In block 902B, the ad system 108 receives a first selection of one of the identified AMs from a first advertiser device 110. In block 904B, the ad system 108 also receives a first ad bid price associated with the first selection from the first advertiser device 110. In block 906B, the ad system 108 receives a second selection of the identified AM (i.e., of the same AM) from a second advertiser device 110. In block 908B, the ad system 108 also receives a second ad bid price associated with the second selection from the second advertiser device 110.

In block 910B, the ad system 108 generates a cumulative, or total, ad bid price based on the first and second ad bid prices received from the first and second advertiser devices 110. For example, the ad system 108 may compute a sum the first and second ad bid prices to generate the cumulative ad bid price. In block 912B, the ad system 108 may store the cumulative ad bid price in an ad record (e.g., the ad record 234). In some examples, the ad record may further include indications of the first and second selections and/or the first and second ad bid prices used to generate the cumulative ad bid price.

Blocks 902C-908C are analogous to blocks 902B-908B. In contrast to the method 900B, in block 910C, the ad system 108 generates a cumulative ad bid number based on the first and second selections of the identified AM and/or the first and second ad bid prices received from the first and second advertiser devices 110. For example, the ad system 108 may compute a total number of the first and second selections of the identified AM, or a total number of the first and second ad bid prices, to generate the cumulative ad bid number. In block 912C, the ad system 108 may store the cumulative ad bid number in an ad record. In some examples, the ad record may further include the indications of the first and second selections and/or the first and second ad bid prices used to generate the cumulative ad bid number. In other examples, the ad record may also include the cumulative ad bid price.

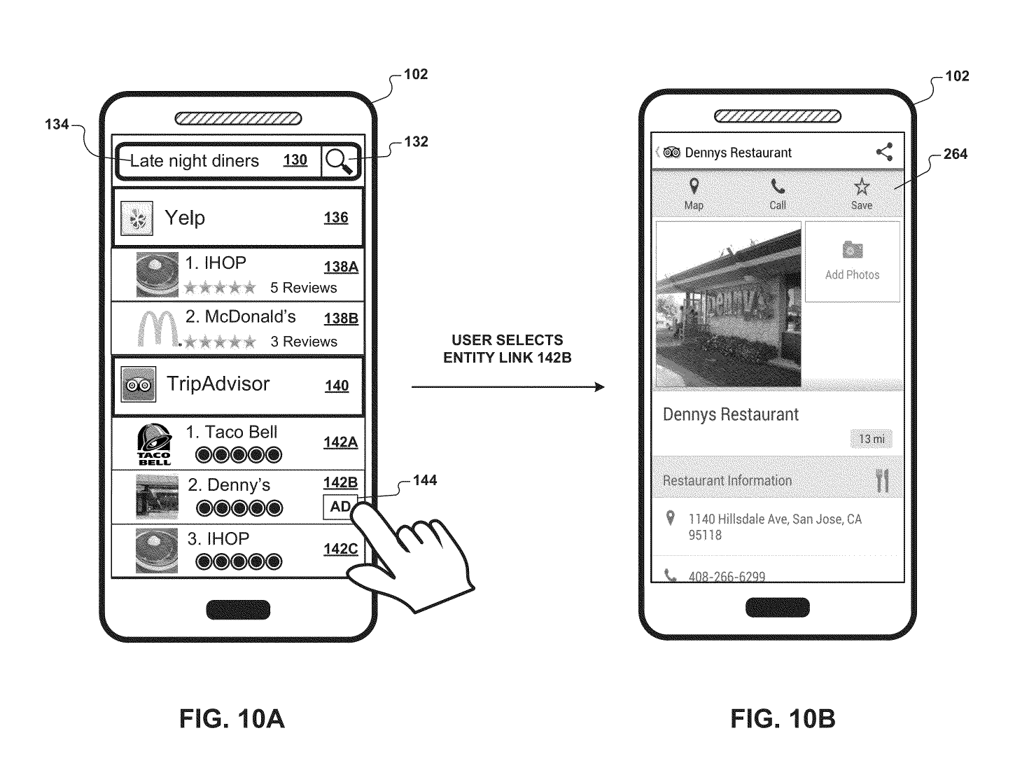

FIGS. 10A-10B illustrate example GUIs that may be generated on the user device 102 according to the present disclosure. Specifically, FIG. 10A shows an example GUI of a search application included on the user device 102. FIG. 10B, in turn, shows an example GUI of a native application included on the user device 102 after the application has been set into a particular application state. In FIG. 10A, a user has entered a search query 134 (“Late night diners”) into a search field 130 of the GUI. The user has selected (e.g., touched, or clicked on) a search button 132 of the GUI, causing the user device 102 to transmit the search query 134 to the search system 100 as part of a query wrapper. The search system 100 has received the query wrapper from the user device 102, and has identified multiple AMs based on the search query 134 included in the query wrapper.

In the example of FIG. 10A, the search system 100 has identified AMs that specify application states within native applications Yelp and TripAdvisor. Specifically, the search system 100 has identified AMs that correspond to entries in Yelp for “IHOP” and “McDonald's,” The search system 100 has also identified AMs that correspond to entries in TripAdvisor for “Taco Bell,” “Denny's,” and “MOP.” In this example, the search system 100 has transmitted the AMs that correspond to the entries in Yelp and the entries in TripAdvisor for “Taco Bell” and “IHOP” to the user device 102 as part of search results. The search system 100 has transmitted the AM that corresponds to the entry in TripAdvisor for “Denny's” to the ad system 108. The search system 100 may have also transmitted one or more other AMs identified based on the search query 134 to the ad system 108. In some examples, the ad system 108 may have determined that the AM that corresponds to the entry in TripAdvisor for “Denny's” is associated with a total ad bid price that is greater than a total ad bid price associated with any of the other AMs transmitted by the search system 100 to the ad system 108. In other examples, the ad system 108 may have determined that the AM is associated with a total ad bid number that is greater than a total ad bid number associated with any of the other AMs. In still other examples, the ad system 108 may have determined that the AM is associated with a total ad bid price and a total ad bid number that are each greater than a corresponding one of a total ad bid price and a total ad bid number associated with any of the other AMs. In still other examples, the ad system 108 may have determined that the AM is associated with a value of another cumulative ad bid parameter that is greater than a value of the same parameter associated with any of the other AMs, as described herein. In any case, based on the corresponding determination, the ad system 108 has transmitted the AM to the user device 102 as part of advertised search results. The ad system 108 may have also determined that none of the other AMs transmitted by the search system 100 to the ad system 108 is associated with a total ad bid price and/or number that are greater than the corresponding ones of the total ad bid price and/or number associated with the transmitted AM, and has thus refrained from transmitting the other AMs to the user device 102 as part of the advertised search results.

In this example, the AMs transmitted to the user device 102 as part of the search results may correspond to a first subset of the AMs identified by the search system 100 based on the search query 134 and the AMs transmitted to the ad system 108 may correspond to a second subset of the identified AMs. The search system 100 may have selected the first and second subsets of the identified AMs based on result scores associated with the identified AMs. For example, the result scores may indicate how relevant each of the AMs is to the search query 134. As one example, the first subset may include AMs that are relatively more relevant to the search query 134 compared to the AMs included in the second subset, as indicated by the corresponding result scores. In other examples, the first and second subsets may include one or more common AMs and/or all or a subset of the identified AMs, as described herein.

In this example, the search system 100 has also transmitted link data (e.g., text and/or image data) associated with each AM included in the search results to the user device 102. The search system 100 has also transmitted link data associated with the AM that corresponds to the entry in TripAdvisor for “Denny's” to the ad system 108. After determining that the AM is associated with a highest total ad bid price, a highest total ad bid number, or a highest value of another cumulative ad bid parameter, as described herein, the ad system 108 has transmitted the link data to the user device 102 as part of the advertised search results. The ad system 108 has also transmitted ad content (e.g., text and/or image data) to the user device 102 as part of the advertised search results. The user device 102 has generated user selectable links (“links”) 136, 138A-138B, 140, and 142A-142C shown in FIG. 10A using the AMs and the associated link data and the ad content. Specifically, the user device 102 has generated the links 136 and 138A-138B for the received AMs that specify the above-described entries in Yelp, and links 140 and 142A-142C for the received AMs that specify the above-described entries in TripAdvisor. The user device 102 has generated a portion of the link 142B (the GUI element 144 with the string “AD”) that indicates that the link 142B is for an advertised search result using the received ad content.

Although FIG. 10A depicts the link 142B as being the second link under the link 140 (i.e., the header) for TripAdvisor, in other examples, the link 142B may be located in any other position with respect to the link 140. For example, the link 142B may be shown as the first link, the last link, or as any other link other than the second link, under the link 140.

In this example, the user device 102 may have generated the link 136 (i.e., the header) for Yelp and/or the link 140 (i.e., the header) for TripAdvisor without having received AMs that were identified by the search system 100 based on the search query 134. Instead, the user device 102 may have generated the links 136, 140 using one or more of the AMs that correspond to the links 138A-138B and 142A-142C, or portions thereof. In some examples, the user selecting the link 136 or the link 140 may cause the user device 102 to launch Yelp or TripAdvisor, and set Yelp or TripAdvisor into a default (e.g., main) application state.

As shown in FIG. 10A, each of the links 136, 138A-138B, 140, and 142A-142C includes text and/or image data (e.g., the text “IHOP” and the image of pancakes included in the link 138A for the entry in Yelp for “IHOP”). As also shown, some of the links include other data, such as user ratings data (e.g., in the form of one to five stars or circles), user review data, and application state enumeration data. The text and/or image data and other data for each link may be included in link data associated with the corresponding AM. The user may select (e.g., touch, or click on) any of the links 136, 138A-138B, 140, and 142A-142C to cause the user device 102 to access the corresponding application state within a web-based or native application using the associated AM. For example, the user may select an area of the example GUI of FIG. 10A that includes the link to cause the user device 102 to access the application state.

In the example GUI of FIG. 10A, the links 136, 138A-138B, 140, and 142A-142C are grouped according to the applications associated with the links. For example, the links 136 and 138A-138B are grouped together under the header “Yelp,” with the link 136 corresponding to the header. Similarly, the links 140 and 142A-142C are grouped together under the header “TripAdvisor,” with the link 140 corresponding to the header. In other examples, the links 136, 138A-138B, 140, and 142A-142C, or one or more other links, may be distributed differently than shown in FIG. 10A (e.g., the links may not be grouped according to the associated applications).

Although only user selectable links for Yelp and TripAdvisor are shown in the GUI of FIG. 10A, the search system 100 may have identified additional AMs that specify application states within these applications, or within other web-based or native applications. The search system 100 may have transmitted the additional AMs to the user device 102 (e.g., via the ad system 108 in the manner described above). The user device 102 may generate user selectable links not shown in FIG. 10A for the additional AMs.

In the example of FIGS. 10A-10B, the user selects the link 142B that corresponds to the entry in TripAdvisor for a particular “Denny's®” restaurant and/or the GUI element 144 associated with the link 142B. In response to the user selecting the link 142B and/or the GUI element 144, the user device 102 launches TripAdvisor and sets it into the application state specified by the AM associated with the link 142B. In this example, the AM may reference TripAdvisor and indicate a path (e.g., within the user device 102, or via a remote server) for TripAdvisor to find information for the Denny's restaurant associated with the link 142B. For example, the AM may be an AAM that includes an ARI that references TripAdvisor and indicates one or more operations for TripAdvisor to perform, such as retrieving data using the path indicated by the AAM. Accordingly, the ARI of the AAM may cause TripAdvisor to perform the function of retrieving and displaying the information for the Denny's restaurant.

FIG. 10B illustrates an example GUI 264 of a native application version of TripAdvisor that corresponds to the application state within TripAdvisor indicated by the link 142B. In other words, the application state within TripAdvisor, as depicted in FIG. 10B, is specified by the AM associated with the link 142B. The user device 102 may set TripAdvisor into the application state shown in FIG. 10B by causing TripAdvisor to perform the one or more operations specified by the AM. As described herein, the user device 102 sets TripAdvisor into the application state shown in FIG. 10B in response to the user selecting the link 142B and/or the GUI element 144 within the GUI shown in FIG. 10A. As shown in FIG. 10B, the GUI 264 includes information regarding the particular Denny's restaurant associated with the link 142B.

FIGS. 11A-11B illustrate other example GUIs that may be generated on the user device 102 according to the present disclosure. FIG. 11A is analogous to FIG. 10A described above. In other words, like FIG. 10A, FIG. 11A also shows an example GUI of a search application included on the user device 102. In contrast to FIG. 10B, FIG. 11B shows an example GUI of the same search application after a user of the user device 102 has selected one or more GUI elements associated with the link 142B (e.g., the GUI element 144, or the link 142B itself). Specifically, as depicted in FIG. 11B, upon the user selecting the link 142B and/or the GUI element 144, rather than setting TripAdvisor into the application state shown in FIG. 10B, the user device 102 causes the search application to display an indication of each of one or more advertisers associated with the link 142B to the user. In this example, each of the advertisers may have included the AM used to generate the link 142B in the advertiser's advertisement bid, as described herein. For example, each advertiser may have selected the AM from among one or more AMs responsive to the advertiser's entity query, and specified an entity bid amount value (e.g., an ad bid price) to be associated with the AM in an ad record.

FIG. 12 illustrates an example GUI 268 that may be generated on any of the advertiser devices 110 according to the present disclosure. As shown in FIG. 12, the GUI 268 includes an entity search field 270 and an entity search button 272. In the example of FIG. 12, the entity search field 270 includes an entity query 274 (“RESTAURANTS”), which has been entered into the entity search field 270 by a user (e.g., an advertiser) of the advertiser device 110. In this example, the user has submitted the entity query 274 to the advertiser device 110 by selecting (e.g., touching, or clicking on) the entity search button 272. In response to the user submitting the entity query 274, the advertiser device 110 has transmitted the entity query 274 to the ad system 108. The ad system 108 has received the entity query 274, identified one or more AMs based on the entity query 274 (e.g., using entity record(s) and/or function record(s), as described herein), and transmitted the identified AMs to the advertiser device 110. The advertiser device 110 has received the identified AMs from the ad system 108 and displayed the AMs to the user within the GUI 268 as one or more selectable AMs.

As shown in FIG. 12, the GUI 268 includes a result GUI element 276 that lists some of the identified AMs (“AM1-AM4”) as selectable AMs 282A-282D under a header 280 that indicates a web-based or native application (in this example, “Yelp”) associated with the AMs. The result GUI element 276 also includes a scroll bar that enables the user to navigate the selectable AMs 282A-282D and/or additional selectable AMs for other received identified AMs associated with Yelp that are not visible within the result GUI element 276. As also shown, the GUI 268 includes a selection box 278 proximate to the result GUI element 276. In this example, the user may select (e.g., touch, or click on) the selection box 278 to include or exclude the AMs that correspond to the selectable AMs 282A-282D from the user's advertisement bid, as explained herein. As one example, the user selecting the selection box 278 may include all AMs associated with Yelp in the user's advertisement bid. As another example, the user selecting the selection box 278 may remove all AMs associated with Yelp from consideration for the user's advertisement bid. In this manner, the user may remove AMs associated with a particular application that the user feels is not relevant for the user's advertising purposes. The user may also individually select (e.g., touch, or click on) one or more of the selectable AMs 282A-282D to include the corresponding one or more AMs in the user's advertisement bid, as also explained herein. In some examples, the GUI 268 may also include a geo-location filter to assist the user in selecting AMs that are relevant to certain geo-locations. For example, using the filter, the user may view only the identified AMs that are relevant to the user's current location (e.g., obtained via a GPS), or to a user-specified location (e.g., a city, state, or country). In other examples, the user's advertisement bid may include all of the identified AMs that are responsive to the entity query 274, without the user selecting any selectable AMs or specifying a geo-location.

In the example of FIG. 12, the advertiser device 110 has also received other identified AMs that are responsive to the entity query 274, in addition to the identified AMs AM1-AM4 that are rendered as the selectable AMs 282A-282D. The additional AMs (“AM5-AM12”) correspond to the applications TripAdvisor and Urbanspoon and are also rendered as selectable AMs. As shown in FIG. 12 the GUI 268 includes result GUI elements, headers, scroll bars, and selection boxes for the selectable AMs corresponding to these additional AMs.

As shown in FIG. 12, the GUI 268 includes a preview GUI element 284. The preview GUI element 284 provides a preview of an application state that is accessed using an AM (in this example, AM2 corresponding to the selectable AM 2828) selected by the user. For example, the user may select (e.g., touch, or click on, to highlight) a selectable AM included in a result GUI element of the GUI 268 (e.g., the result GUI element 276) that corresponds to an AM. In response to the user selecting the selectable AM, the preview GUI element 284 may display a preview of an application state that is accessed using the AM. For example, the preview GUI element 284 may display a web page within a web-based application, or a GUI, or screen, within a native application, referenced by the AM. Additionally, or alternatively, the preview GUI element 284 may display a user selectable link for the AM as it will appear in search results responsive to a user's search query. In this manner, the preview GUI element 284 enables the user to preview an application state specified by a particular one of the identified AMs, and/or a user selectable link for the AM, prior to including the AM in the user's advertisement bid.

As also shown in FIG. 12, the GUI 268 includes a selected AM bid data GUI element 292. The GUI element 292 provides information regarding any existing bids associated with an AM (in this example, AM2 corresponding to the selectable AM 282B) selected by the user. In other words, the GUI element 292 indicates whether the AM selected by the user is included in any other users' (e.g., advertisers') advertisement bids. For example, the user may select a selectable AM included in a result GUI element of the GUI 268 that corresponds to an AM. As shown in FIG. 12, in response to the user selecting the selectable AM, the GUI element 292 may display one or more entity bid amount values (e.g., ad bid prices) specified by one or more users (e.g., advertisers) that have included the corresponding AM in their advertisement bids. Additionally, as also shown, the GUI element 292 may display one or more aggregated, or cumulative values derived using the entity bid amount values, the advertisers, and their advertisement bids, such as a total entity bid amount value (e,g., a total ad bid price), a total number of sponsors or advertisement bids (e.g., a total ad bid number), as well as any other aggregated, or cumulative parameters derived using any of the data described above.

As further shown in FIG. 12, the GUI 268 includes additional GUI elements, namely an entity bid amount field label 286, an entity bid amount field 288, and a bid button 290, that enable the user to associate an advertisement bid amount value (e.g., an ad bid price) with the one or more AMs included in the user's advertisement bid. As described herein, the user may select one or more of the identified AMs to be included in the user's advertisement bid by selecting one or more selectable AMs associated with the AMs. For example, the user may select each of the selectable AMs 282A-282D by selecting the selection box 278, or some of the selectable AMs 282A-282D by selecting the corresponding selectable AMs individually. In this manner, the user may select one or more of the AMs AM1-AM4 to be included in the user's advertisement bid. In some examples, the user may not own, or be required to own the AMs included in the user's advertisement bid. In other words, in these examples, the user may not own the AMs URLs) on which the user is bidding. As explained herein, prior to selecting the AMs, the user may preview any of the AMs AM1-AM4 within the preview GUI element 284 by selecting the corresponding ones of the selectable AMs 282A-282D. As also explained herein, prior to selecting the AMs, the user may view information regarding any existing bids associated with any of the AMs AM1-AM4 within the GUI element 292 by selecting the corresponding ones of the selectable AMs 282A-282D.

Upon selecting the one or more AMs, the user may enter an entity bid amount value (e.g., an ad bid price) into the entity bid amount field 288. The entity bid amount value may specify an amount of money the user is willing to pay to advertise the AMs selected by the user. The user may select (e.g., touch, or click on) the bid button 290 to submit the user's advertisement bid, including the selected AMs and the entity bid amount value specified by the user. In some examples, upon selecting the bid button 290, the ad system 108 may generate an ad record that includes the selected AMs and the entity bid amount value. For example, the ad system 108 may generate the ad record in cases where no other user (e.g., advertiser) of any of the advertiser devices 110 has submitted an advertisement bid that includes the selected AMs and an entity bid amount value. In other examples, upon selecting the bid button 290, the ad system 108 may store the selected AMs and the entity bid amount value in an existing ad record. For example, the ad record may already exist in cases where one or more other users (e.g., advertisers) of any of the advertiser devices 110 have each submitted an advertisement bid that includes the selected AMs and an entity bid amount value.

The modules and data stores included in the search systems 100, the ad system 108, and the entity system 112 represent features or functionality that may be included in these systems 100, 108, 112 as they are described in the present disclosure. For example, the search module 114, the result generation module 116, the data store 118, and the components thereof may represent features included in the search system 100. Similarly, the ad generation module 120, the ad record generation module 122, the data store 124, and the components thereof may represent features included in the ad system 108. Likewise, the entity record generation module 126, the data store 128, and the components thereof may represent features included in the entity system 112. The modules and data stores described herein may be embodied by electronic hardware, software, firmware, or any combination thereof. Depiction of different features or functionality as separate modules or data stores does not necessarily imply whether the modules or data stores are embodied by common or separate electronic hardware, software, or firmware components. In some implementations, the features or functionality associated with one or more of the modules and data stores depicted herein may be realized by common or separate electronic hardware, software, or firmware components.

The modules and data stores may be embodied by electronic hardware, software, and/or firmware components including, but not limited to, one or more processing units, one or more memory components, one or more input/output (I/O) components, and one or more interconnect components. The interconnect component(s) may be configured to provide communication between the processing unit(s), memory component(s), and I/O component(s). For example, the interconnect component(s) may include one or more buses that are configured to transfer data between electronic components. The interconnect component(s) may also include one or more control circuits (e.g., a memory controller and/or an I/O controller) that are configured to control communication between electronic components.

The processing unit(s) may include one or more central processing units (CPUs), graphics processing units (GPUs), digital signal processing units (DSPs), application specific integrated circuits (ASICs), field programmable gate arrays (FPGAs), or other processing units. The processing unit(s) may be configured to communicate with the memory component(s) and the I/O component(s). For example, the processing unit(s) may be configured to communicate with the memory component(s) and the I/O component(s) via the interconnect component(s).

A memory component as described herein may include any volatile or non-volatile media. For example, a memory component may include, but is not limited to, electrical media, magnetic media, and/or optical media, such as random access memory (RAM), non-volatile RAM (NVRAM), read-only memory (ROM), electrically-erasable programmable ROM (EEPROM), Flash memory, solid state drives (SSDs), hard disk drives (HDDs), magnetic tape drives, optical storage technology (e.g., compact disc (CD), digital versatile disc (DVD), and/or Blu-ray Disc), or any other equivalent or similar memory components.

As such, the one or more memory component(s) may include (e.g., store) various types of data. For example, the memory component(s) may store data included in one or more of the function records(s) of the data store 118, the ad record(s) of the data store 124, and the entity record(s) of the data store 128. The memory component(s) may also include one or more instructions that may be executed by the processing unit(s). For example, the memory component(s) may include one or more computer-readable instructions that, when executed by the processing unit(s), cause the processing unit(s) to perform the various functions attributed to the modules and data stores described herein.

The I/O component(s) may refer to electronic hardware, software, and/or firmware that provide communication with a variety of different devices. For example, the I/O component(s) may provide communication between other devices and the processing unit(s) and the memory component(s). In some examples, the I/O component(s) may be configured to communicate with a computer network, such as the network 106. For example, the I/O component(s) may be configured to exchange data over a computer network using any of a variety of different physical connections, wireless connections, and protocols. The I/O component(s) may include, but are not limited to, one or more network interface components (e.g., a network interface controller), repeaters, network bridges, network switches, routers, and firewalls. In some examples, the I/O component(s) may include hardware, software, and/or firmware that is configured to communicate with various human interface devices, including, but not limited to, display screens, keyboards, pointer devices (e.g., a mouse), touchscreens, speakers, and microphones. In other examples, the I/O component(s) may provide communication with additional devices, such as external memory (e.g., external HDDs).

In some implementations, one or more of the search system 100, ad system 108, and entity system 112 may be a system of one or more computing devices (e.g., a computer-based search system that includes an advertisement system or component) that are configured to implement the techniques described herein. In other words, the features or functionality attributed to the modules and data stores described herein may be implemented by one or more computing devices. Each of the computing device(s) may include any combination of electronic hardware, software, and/or firmware, as described above. Additionally, each computing device may include any combination of processing units, memory components, I/O components, and interconnect components, as also described above. The computing device(s) of any of the systems 100, 108, and 112 may also include various human interface devices, including, but not limited to, display screens, keyboards, pointing devices (e.g., a mouse), touchscreens, speakers, and microphones. The computing device(s) may also he configured to communicate with additional devices, such as external memory (e.g., external HDDs).

The computing device(s) of any of the search system 100, ad system 108, and entity system 112 may be configured to communicate with the network 106. The computing device(s) may also be configured to communicate with one another (e.g., within any of, or between, the systems 100, 108, and 112) via a computer network. In some examples, the computing device(s) may include one or more server computing devices configured to communicate with user devices, such as the user device(s) 102, or the advertiser devices 110 (e.g., receive search queries and transmit search results, or receive ad content and related data, generate advertisements, and transmit the advertisements). The server computing device(s) may also gather data from the data source(s) 104, index the data, and store the data, as well as gather, index, and/or store other documents or information. The computing device(s) of any of the systems 100, 108, and 112 may reside within a single machine or within multiple machines at a single geographic location, or may be distributed across a number of geographic locations.

Additionally, the various implementations of the search system 100, ad system 108, and entity system 112 described above (e.g., using one or more computing devices that include one or more processing units, memory components, I/O components, and interconnect components) are equally applicable to any of the user device(s) 102 and the advertiser devices 110, as well as to the various components thereof, as described herein.

What is claimed is:

1. A method comprising:
receiving, at a computing device, a search query from a user device;
identifying, by the computing device, access mechanisms (AMs) based on the search query, wherein each AM specifies an application state of an application;
selecting, by the computing device, first and second subsets of the identified AMs, wherein each subset includes one or more of the AMs;
generating, by the computing device, search results based on the first subset;
determining, by the computing device, whether an AM included in the second subset is associated with one or more of a highest total advertisement (ad) bid price and a highest total ad bid number among the one or more AMs included in the second subset;
in the event an AM included in the second subset is associated with the one or more of the highest total ad bid price and the highest total ad bid number, generating, by the computing device, an advertised search result based on AM, and transmitting the search results and the advertised search result from the computing device to the user device; and
in the event an AM included in the second subset is not associated with the one or more of the highest total ad bid price and the highest total ad bid number, transmitting the search results from the computing device to the user device.

2. The method of claim 1, wherein determining whether an AM included in the second subset is associated with the one or more of the highest total ad bid price and the highest total ad bid number comprises:
for each of the one or more AMs included in the second subset, determining whether the AM is the same as an advertised AM referenced by one or more indications of selections of the advertised AM stored in an ad record, wherein the ad record also includes one or more ad bid prices associated with the selections; and
determining whether an AM included in the second subset is associated with the one or more of the highest total ad bid price and the highest total ad bid number based on each of the one or more AMs included in the second subset that is the same as an advertised AM.

3. The method of claim 2, wherein determining whether an AM included in the second subset is associated with the one or more of the highest total ad bid price and the highest total ad bid number based on each of the one or more AMs included in the second subset that is the same as an advertised AM comprises:
comparing the one or more AMs included in the second subset that are each the same as an advertised AM based on at least one of the one or more indications of selections of an advertised AM and the one or more ad bid prices corresponding to each AM; and
determining whether an AM included in the second subset is associated with the one or more of the highest total ad bid price and the highest total ad bid number based on the comparison.

4. The method of claim 3, wherein comparing the one or more AMs included in the second subset that are each the same as an advertised AM based on the at least one of the one or more indications of selections of an advertised AM and the one or more ad bid prices corresponding to each AM comprises:
for each ad record corresponding to the one or more AMs, generating one or more of a total ad bid price that represents a sum of all ad bid prices stored in the ad record and a total ad bid number that indicates one of a number of all indications of selections of an advertised AM and a number of all ad bid prices associated with the selections stored in the ad record; and
comparing the one or more of the total ad bid price and the total ad bid number generated for each ad record to one another,

5. The method of claim 2, wherein determining whether an AM included in the second subset is associated with the one or more of the highest total ad bid price and the highest total ad bid number based on each of the one or more AMs included in the second subset that is the same as an advertised AM comprises determining that only one of the one or more AMs included in the second subset is the same as an advertised AM, and, in response to the determination, determining that the AM is associated with the one or more of the highest total ad bid price and the highest total ad bid.

6. The method of claim 2, further comprising:
receiving, at the computing device, a first entity query from a first advertiser;
identifying, by the computing device, an AM included in the second subset based on the first entity query;
displaying the AM to the first advertiser;
receiving, at the computing device, a first selection of the AM from the first advertiser;
receiving, at the computing device, a first ad bid price associated with the first selection from the first advertiser;
receiving, by the computing device, a second entity query from a second advertiser, wherein the second advertiser is different than the first advertiser;
identifying, by the computing device, the AM based on the second entity query;
displaying the AM to the second advertiser;
receiving, at the computing device, a second selection of the AM from the second advertiser;
receiving, at the computing device, a second ad bid price associated with the second selection from the second advertiser; and
storing, by the computing device, one or more of indications of the first and second selections of the AM and the first and second ad bid prices in an ad record.

7. The method of claim 6, wherein the ad record associates the one or more of the indications of the first and second selections of the AM and the first and second ad bid prices stored in the ad record.

8. The method of claim 1, wherein the first and second subsets of the identified AMs are mutually exclusive.

9. The method of claim 8, wherein the first and second subsets of the identified AMs comprise a subset of the identified AMs, and wherein the subset includes AMs that are each more relevant to the search query than each of one or more AMs included in a portion of the identified AMs other than the subset.

10. The method of claim 1, wherein the first and second subsets of the identified AMs each include at least one common AM of the identified AMs.

11. The method of claim 1, further comprising generating, by the computing device, result scores that are associated with the identified AMs, wherein selecting the first and second subsets of the identified AMs comprises selecting the first and second subsets based on the result scores.

12. The method of claim 1, wherein generating the search results based on the first subset of the identified AMs comprises retrieving at least one of text and image data for the first subset of the identified AMs, and generating the search results based on the at least one of text and image data.

13. The method of claim 1, wherein generating the advertised search result based on the AM included in the second subset comprises:
retrieving at least one of text and image data for the AM;
retrieving ad data associated with the AM; and
generating the advertised search result based on the at least one of text and image data and the ad data.

14. The method of claim 13, wherein retrieving the ad data associated with the AM included in the second subset comprises retrieving the ad data from an ad record that includes one or more indications of selections of the AM and one or more ad bid prices associated with the selections used to determine that the AM is associated with the one or more of the highest total ad bid price and the highest total ad bid number.

15. The method of claim 1, wherein identifying the AMs based on the search query comprises:
identifying function records included in a data store based on the search query, wherein each function record includes an AM specifying an application state of an application, and application state information (ASI) describing the application state of the application, and wherein identifying the function records based on the search query comprises identifying the function records based on one or more matches between one or more terms of the search query and one or more terms of the ASI included in each identified function record; and
selecting the identified AMs from the identified function records.

16. The method of claim 15, further comprising generating, by the computing device, result scores for the identified function records, wherein selecting the first and second subsets of the identified AMs comprises selecting the first and second subsets based on the result scores for the identified function records from which the identified AMs are selected.

17. A method comprising:
receiving, at a computing device, a first entity query from a first advertiser;
identifying, by the computing device, an access mechanism (AM) based on the first entity query, wherein the AM specifies an application state of an application;
displaying the AM to the first advertiser;
receiving, at the computing device, a first selection of the AM from the first advertiser;
receiving, at the computing device, a first advertisement (ad) bid price associated with the first selection from the first advertiser;
receiving, at the computing device, a second entity query from a second advertiser, wherein the second advertiser is different than the first advertiser;
identifying, by the computing device, the AM based on the second entity query;
displaying the AM to the second advertiser;
receiving, at the computing device, a second selection of the AM from the second advertiser;
receiving, at the computing device, a second ad bid price associated with the second selection from the second advertiser; and
storing, by the computing device, one or more of indications of the first and second selections of the AM and the first and second ad bid prices in an ad record.

18. The method of claim 17, wherein storing the one or more of the indications of the first and second selections of the AM and the first and second ad bid prices in the ad record comprises generating a total ad bid price that represents a sum of the first and second ad bid prices, and storing the total ad bid price in the ad record.

19. The method of claim 17, wherein storing the one or more of the indications of the first and second selections of the AM and the first and second ad bid prices in the ad record comprises generating a total ad bid number that indicates one of a number of the first and second selections and a number of the first and second ad bid prices, and storing the total ad bid number in the ad record.

20. The method of claim 17, wherein storing the one or more of the indications of the first and second selections of the AM and the first and second ad bid prices in the ad record comprises:
generating a cumulative ad bid parameter value based on one or more of the indications of the first and second selections and the first and second ad bid prices, wherein generating the cumulative ad bid parameter value comprises performing one or more algebraic operations using the one or more of the indications of the first and second selections and the first and second ad bid prices; and
storing the cumulative ad bid parameter value in the ad record.

21. The method of claim 20, wherein generating the cumulative ad bid parameter value comprises computing one or more of:
a sum of the first and second ad bid prices multiplied by a number of the indications of the first and second selections;
the sum of the first and second ad bid prices added to the number of the indications of the first and second selections;
an average of the first and second ad bid prices;
the average of the first and second ad bid prices multiplied by the number of the indications of the first and second selections; or
a sum of the average of the first and second ad bid prices and the number of the indications of the first and second selections.

22. The method of claim 17, further comprising:
receiving, at the computing device, a search query from a user device;
identifying, by the computing device, AMs based on the search query, wherein each AM specifies an application state of an application;
selecting, by the computing device, first and second subsets of the identified AMs, wherein each subset includes one or more of the AMs;
generating, by the computing device, search results based on the first subset;
determining, by the computing device, whether an AM included in the second subset is associated with one or more of a highest total ad bid price and a highest total ad bid number among the one or more AMs included in the second subset based on the ad record;
in the event an AM included in the second subset is associated with the one or more of the highest total ad bid price and the highest total ad bid number, generating, by the computing device, an advertised search result based on the AM, and transmitting the search results and the advertised search result from the computing device to the user device; and
in the event an AM included in the second subset is not associated with the one or more of the highest total ad bid price and the highest total ad bid number, transmitting the search results from the computing device to the user device.

23. The method of claim 22, wherein determining whether an AM included in the second subset is associated with the one or more of the highest total ad bid price and the highest total ad bid number based on the ad record comprises:
determining whether an AM included in the second subset is the same as the AM referenced by the indications of the first and second selections; and
in the event an AM included in the second subset is the same as the AM referenced by the indications of the first and second selections, determining whether an AM included in the second subset is associated with the one or more of the highest total ad bid price and the highest total ad bid based on at least one of the one or more of the indications of the first and second selections of the AM and the first and second ad bid prices.

24. The method of claim 23, wherein determining whether an AM included in the second subset is associated with the one or more of the highest total ad bid price and the highest total ad bid based on the at least one of the one or more of the indications of the first and second selections of the AM and the first and second ad bid prices comprises:
comparing the at least one of the one or more of the indications of the first and second selections of the AM and the first and second ad bid prices to at least one of one or more indications of selections of other AMs included in the second subset and one or more ad bid prices associated with the selections stored in one or more other ad records; and
determining whether an AM included in the second subset is associated with the one or more of the highest total ad bid price and the highest total ad bid number based on the comparison.

25. The method of claim 24, wherein comparing the at least one of the one or more of the indications of the first and second selections of the AM and the first and second ad bid prices to the at least one of the one or more indications of selections of other AMs and the one or more ad bid prices associated with the selections comprises:
for each of the ad record and the one or more other ad records, generating one or more of a total ad bid price that represents a sum of all ad bid prices stored in the ad record and a total ad bid number that indicates one of a number of all indications of selections of an AM and a number of all ad bid prices associated with the selections stored in the ad record; and
comparing the one or more of the total ad bid price and the total ad bid number associated with each ad record to one another.

26. The method of claim 23, wherein determining whether an AM included in the second subset is associated with the one or more of the highest total ad bid price and the highest total ad bid based on the at least one of the one or more of the indications of the first and second selections of the AM and the first and second ad bid prices comprises:
determining that the AM included in the second subset that is the same as the AM referenced by the indications of the first and second selections is the only AM included in the second subset that is referenced by an indication of a selection of an AM stored in an ad record; and
determining that the AM is associated with the one or more of the highest total ad bid price and the highest total ad bid based on the determination.

27. A system comprising:
a non-transitory data store including a plurality of access mechanisms (AMs), wherein each AM specifies an application state of an application; and
one or more computing devices in communication with the non-transitory data store and configured to:
receive a search query from a user device;
identify AMs in the data store based on the received search query;
select first and second subsets of the identified AMs, wherein each subset includes one or more of the AMs;
generate search results based on the first subset;
determine whether an AM included in the second subset is associated with one or more of a highest total advertisement (ad) bid price and a highest total ad bid number among the one or more AMs included in the second subset;
in the event an AM included in the second subset is associated with the one or more of the highest total ad bid price and the highest total ad bid number, generate an advertised search result based on the AM, and transmit the search results and the advertised search result to the user device; and
in the event an AM included in the second subset is not associated with the one or more of the highest total ad bid price and the highest total ad bid number, transmit the search results to the user device.

28. A system comprising:
a non-transitory data store including a plurality of access mechanisms (AMs), wherein each AM specifies an application state of an application; and
one or more computing devices in communication with the non-transitory data store and configured to:
receive a first entity query from a first advertiser;
identify an AM in the data store based on the first entity query;
display the AM to the first advertiser;
receive a first selection of the AM from the first advertiser;
receive a first advertisement (ad) bid price associated with the first selection from the first advertiser;
receive a second entity query from a second advertiser, wherein the second advertiser is different than the first advertiser;
identify the AM in the data store based on the second entity query;
display the AM to the second advertiser;
receive a second selection of the AM from the second advertiser;
receive a second ad bid price associated with the second selection from the second advertiser; and
associate one or more of the first and second selections of the. AM and the first and second ad bid prices within an ad record.

29. A computer program product encoded on a non-transitory computer readable storage medium comprising instructions that when executed by a data processing apparatus cause the data processing apparatus to perform operations comprising:
receiving a search query from a user device;
identifying access mechanisms (AMs) based on the search query, wherein each AM specifies an application state of an application;
selecting first and second subsets of the identified s, wherein each subset includes one or more of the AMs;
generating search results based on the first subset;
determining whether an AM included in the second subset is associated with one or more of a highest total advertisement (ad) bid price and a highest total ad bid number among the one or more AMs included in the second subset;
in the event an AM included in the second subset is associated with the one or more of the highest total ad bid price and the highest total ad bid number, generating an advertised search result based on the AM, and transmit the search results and the advertised search result to the user device; and
in the event an AM included in the second subset is not associated with the one or more of the highest total ad bid price and the highest total ad bid number, transmitting the search results to the user device.

30. A computer program product encoded on a non-transitory computer readable storage medium comprising instructions that when executed by a data processing apparatus cause the data processing apparatus to perform operations comprising:
receiving a first entity query from a first advertiser;
identifying an access mechanism (AM) based on the first entity query, wherein the AM specifies an application state of an application;
displaying the AM to the first advertiser;
receiving a first selection of the AM from the first advertiser;
receiving a first advertisement (ad) bid price associated with the first selection from the first advertiser;
receiving a second entity query from a second advertiser, wherein the second advertiser is different than the first advertiser;
identify the AM based on the second entity query;
displaying the AM to the second advertiser;
receiving a second selection of the AM from the second advertiser;
receiving a second ad bid price associated with the second selection from the second advertiser; and
storing one or more of indications of the first and second selections of the AM and the first and second ad bid prices in an ad record.

31. A method comprising:
receiving, at a computing device, a search query from a user device;
identifying, by the computing device, access mechanisms (AMs) based on the search query, wherein each AM specifies an application state of an application;
selecting, by the computing device, first and second subsets of the identified AMs, wherein each subset includes one or more of the AMs;
generating, by the computing device, search results based on the first subset;
determining, by the computing device, whether an AM included in the second subset is associated with a highest total advertisement (ad) bid price among the one or more AMs included in the second subset;
in the event an AM included in the second subset is associated with the highest total ad bid price, generating, by the computing device, an advertised search result based on AM, and transmitting the search results and the advertised search result from the computing device to the user device; and
in the event an AM included in the second subset is not associated with the highest total ad bid price, transmitting the search results from the computing device to the user device.

32. A method comprising:
receiving, at a computing device, a search query from a user device;
identifying, by the computing device, access mechanisms (AMs) based on the search query, wherein each AM specifies an application state of an application;
selecting, by the computing device, first and second subsets of the identified AMs, wherein each subset includes one or more of the AMs;
generating, by the computing device, search results based on the first subset;
determining, by the computing device, whether an AM included in the second subset is associated with a highest total advertisement (ad) bid number among the one or more AMs included in the second subset;
in the event an AM included in the second subset is associated with the highest total ad bid number, generating, by the computing device, an advertised search result based on AM, and transmitting the search results and the advertised search result from the computing device to the user device; and
in the event an AM included in the second subset is not associated with the highest total ad bid number, transmitting the search results from the computing device to the user device.
